(19) United States
(12) Patent Application Publication
(10) Pub. No.: US 2023/0053941 A1
(43) Pub. Date: Feb. 23, 2023

(54) MICROEMULSIONS WITH DICAMBA SALTS HAVING IMPROVED PROPERTIES

(71) Applicant: MONSANTO TECHNOLOGY LLC, Saint Louis, MO (US)

(72) Inventor: Ganiyu JIMOH, Saint Louis, MO (US)

(21) Appl. No.: 17/792,611

(22) PCT Filed: Jan. 14, 2021
(86) PCT No.: PCT/US2021/013467

§ 371 Date: Jul. 13, 2022

Related U.S. Application Data
(60) Provisional application No. 62/962,338, filed on Jan. 17, 2020.

(30) Foreign Application Priority Data
Feb. 18, 2020 (EP) 20157938.0

(51) Int. Cl. A01N 43/54; A01N 25/04; A01N 57/20; A01N 37/40

(52) U.S. Cl. CPC A01N 43/54; A01N 25/04; A01N 57/20; A01N 37/40

(57) ABSTRACT

The present invention relates to the technical field of crop protection. The present invention primarily relates to herbicide compositions in the form of a microemulsion comprising as compound (A) ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and as compound (B) one or more dicamba salts, in particular to herbicidal microemulsion containing further constituents, said microemulsions having improved properties. The invention also relates to methods of manufacturing such microemulsions and the use of such microemulsions.

### CROSS-REFERENCE TO RELATED APPLICATIONS

This application claims the benefit of and priority to U.S. Provisional Application Ser. No. 62/962,338, filed Jan. 17, 2020, and European Patent Application No. 20157938.0, filed Feb. 18, 2020, the entire disclosures of which are hereby incorporated by reference.

### FIELD OF THE INVENTION

The present invention relates to the technical field of crop protection. The present invention primarily relates to herbicide compositions in the form of a microemulsion comprising as compound (A) ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and as compound (B) one or more dicamba salts, in particular to herbicidal microemulsion containing further constituents, said microemulsions having improved properties. The invention also relates to methods of manufacturing such microemulsions and the use of such microemulsions.

### BACKGROUND OF THE INVENTION

Crop protectant compositions can be formulated in many different ways, with the possibility of the characteristics of the active ingredients and the nature of the formulation giving rise to problems in terms of chemical stability of the active ingredients therein, physical and storage stability of the formulation, efficacy, and applicability of the formulations. Moreover, certain formulations are more advantageous on economic and environmental grounds than others.

Water-based formulations generally have the advantage that they require a low fraction of organic solvents, or none at all. On the other hand, the distribution of the constituents in such formulations is often inadequate unless appropriate combinations of auxiliaries are used. The performance properties of such formulations frequently depend on a large number of variable parameters, making it impossible simply to select components of known systems and to combine them with the active ingredients intended for new formulation, if the resultant formulation is to be biologically active, stable on storage, and ideal from the applications standpoint.

Standard formulations, therefore, are rarely suitable for meeting particular requirements, and it can require a great deal of experimental work to develop an appropriate formulation. Many herbicidal formulations containing water-soluble active crop protectant ingredients have been described. Also, liquid concentrate formulations of two herbicidal active ingredients, one of which is water-soluble and the other of which is oil-soluble, are known in the art.

WO 02/063955 relates to a microemulsions of carfentrazone-ethyl and a water-soluble herbicide.

WO 2011/019652 concerns aqueous herbicidal solution concentrate formulations comprising an auxin herbicide component consisting essentially of auxin herbicide salts and comprising a certain minimum amount of dicamba monoethanolamine salt.

U.S. Pat. No. 6,713,433 teaches liquid concentrate herbicidal emulsion compositions comprising a water-soluble herbicide, an oil-soluble herbicide, a stabilizing amount of water-soluble chlorides, and one or more surfactants.

WO 2017/007873 relates to methods for controlling volunteer glyphosate-resistant corn by applying synergistic mixtures of e.g. [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and glyphosate or a salt thereof.

WO 2018/197418 pertains to highly concentrated solutions of alkanolamine salts of dicamba.

U.S. 2019/0142005 discloses herbicidal compositions based on ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate in combination with the diglycolamine (DGA) salt of dicamba and/or the N,N-bis-(3-aminopropyl)methylamine (BAPMA) salt of dicamba. These dicamba salts are known from U.S. Pat. Nos. 5,175,353 and 8,987,167.

### BRIEF DESCRIPTION OF THE INVENTION

Among the several features of the invention, it may be noted that the herbicidal compositions of the present invention are useful in agriculture wherein at least two herbicidal active ingredients, one of which is an water-soluble herbicide (compound (B)) and the other of which is an oil-soluble herbicide (compound (A)) are coformulated; these compositions exhibit rapid burndown and early visual symptomology; allow for higher loading of herbicidal active ingredients; have prolonged storage stability and are easy to use.

Thus, it has been found that herbicide compositions in the form of a microemulsion comprising compounds (A) and (B), wherein (A) denotes ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and (B) denotes one or more dicamba salts, can exhibit improved properties, in particular in terms of chemical stability of the active ingredients therein, physical and storage stability of the formulation, herbicidal efficacy, and/or applicability of corresponding formulations. More specifically, the herbicide compositions according to the present invention exhibit substantially no crystallization or phase separation when stored at a temperature of from about −20° C. to about 40° C. for a period of several weeks.

Further, in the herbicide compositions according to the present invention the ratio by weight of the total amount of compound (A) and the total amount of compound (B) is in the range of from about 1:1 to 1:100.

Still further, the herbicide compositions according to the present invention preferably additionally comprise one or more further constituents selected from the group consisting of herbicidal active compounds (i.e. herbicides different from compounds (A) and (B)), herbicide safeners, formulation auxiliaries and additives customary in crop protection.

Still further, the herbicide compositions according to the present invention preferably comprise a substantially water-immiscible organic solvent.

Still further, the herbicide compositions according to the present invention preferably comprise one or more water-soluble stabilizing agents, preferably one or more water-soluble inorganic stabilizing agents, preferably selected from the group consisting of inorganic halides, in particular of inorganic chlorides.

The herbicide compositions according to the present invention preferably comprise one or more mono carboxylic acids and/or salts thereof.

The herbicide compositions according to the present invention advantageously have an acidic pH-value.

The herbicide compositions according to the present invention preferably comprise a drift retardant agent.

The present invention also relates to a method for controlling undesired plant growth which comprises applying herbicide compositions according to the present invention onto the plants, parts of plants, plant seeds or the area where the plants grow.

Further benefits of the present invention will be apparent to one skilled in the art from the detailed information and preferred embodiments of the invention described in the following.

### DETAILED DESCRIPTION OF THE INVENTION

The invention primarily relates to an herbicide composition in the form of a microemulsion (in the context of the present invention for brevity mostly referred to as “herbicide composition”, and sometimes as “herbicidal microemulsion”) comprising compounds (A) and (B), wherein (A) denotes ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and (B) denotes one or more dicamba salts.

Compound (A) of an herbicide composition according to the present invention can be represented by the following formula (A):

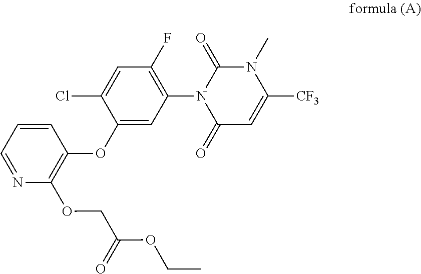 [SMILES: CCOC(=O)COc1ncccc1Oc1cc(-n2c(=O)cc(C(F)(F)F)n(C)c2=O)c(F)cc1Cl]

Compound (B) of an herbicide composition according to the present invention can be any sufficiently water-soluble dicamba salt. Dicamba salts suitable to be used as compound (B) in the context of the present invention are preferably selected from the group consisting of the tetrabutylamine salt of dicamba, the dimethylamine salt of dicamba, the isopropylamine salt of dicamba, the diglycolamine salt of dicamba, the N,N-bis-(3-aminopropyl)methylamine salt of dicamba, the choline salt of dicamba, the monoethanolamine salt of dicamba, the diethanolamine salt of dicamba, the triethanolamine salt of dicamba, the potassium salt of dicamba, and the sodium salt of dicamba.

Compound (B) of an herbicide composition according to the present invention preferably is selected from the group consisting of the diglycolamine salt of dicamba, the N,N-bis-(3-aminopropyl)methylamine salt of dicamba, the monoethanolamine salt of dicamba, the diethanolamine salt of dicamba and the triethanolamine salt of dicamba.

Compound (B) of an herbicide composition according to the present invention particularly preferably is selected from the group consisting of the diglycolamine salt of dicamba, the N,N-bis-(3-aminopropyl)methylamine salt of dicamba, the monoethanolamine salt of dicamba, the diethanolamine salt of dicamba and the triethanolamine salt of dicamba, with particular preference for the diglycolamine salt of dicamba and/or the monoethanolamine salt of dicamba.

A particularly preferred dicamba salt as compound (B) in the context of the present invention is dicamba monoethanolamine salt (dicamba EA salt) since it generally has less tendency to salt out compared to other dicamba salts at higher concentrations.

The salts of dicamba used as compound (B) in herbicide compositions of the present invention are generally known from the prior art. These dicamba salts are readily obtainable in water by neutralization of the dicamba acid (3,6-dichloro-2-methoxybenzoic acid) with the respective inorganic or organic base. The dicamba salts used as compound (B) in the context of the present invention may be used in pure form or as aqueous solution for the preparation of an herbicide composition according to the present invention.

The herbicide compositions according to the present invention are liquid at 25° C. and 1013 mbar.

The herbicide compositions according to the present invention are preferably liquid herbicide concentrates.

Oil-in-water type emulsions have a discontinuous oil phase dispersed in a continuous aqueous phase, typically with the aid of one or more emulsifying agents. The water-soluble active ingredient is contained predominantly in the aqueous phase and the oil-soluble active ingredient is contained predominantly in the oil phase.

The individual oil particles can be large enough to interfere with the transmission of light, giving rise to a cloudy or milky emulsion known as a macroemulsion. However, where the individual oil particles are so small as to allow light to be transmitted without noticeable scattering, the emulsion is clear, i.e. transparent, and is known as a microemulsion. Microemulsions offer several practical advantages, one of the most important being that they one of the most important being that they are thermodynamically stable and typically remain homogeneous without agitation for long periods of time. In this respect, a microemulsion formulation can be handled by an agricultural technician or other user with the same ease and convenience as a simple aqueous solution.

However, selecting excipient ingredients for the preparation of a microemulsion is not necessarily straightforward or easy.

Difficulties in preparing stable microemulsions suitable for effective weed control and good crop safety are compounded when the active ingredients to be formulated are a water-soluble herbicide and an oil-soluble herbicide. For example, one challenge is that water-mediated chemical degradation, e. g., hydrolysis, of the oil-soluble herbicide must be minimized. Minimizing hydrolysis is especially difficult in microemulsions, where the oil particles containing the oil-soluble herbicidal active are extremely small and therefore present a very large interfacial area with the aqueous phase.

Another challenge is that microemulsions must contain surfactants, which tend to facilitate transfer of the oil-soluble herbicidal active across the large interface between the oil and aqueous phases, increasing the potential for chemical degradation. However, surfactants are important to the microemulsion composition, functioning as emulsifying agents to physically stabilize the microemulsion, as dispersants to prevent aggregation of oil particles when the microemulsion is diluted in water for application to plants, and as adjuvants to enhance herbicidal efficacy of one or both active ingredients, for example by improving retention on or adhesion to foliar surfaces of the applied composition or by improving penetration of the active ingredient(s) into or through the cuticles of the plant foliage.

To optimize the chemical and/or physical stability of the herbicide compositions according to the present invention, in particular as liquid herbicide concentrates in the form of microemulsions, several parameters were investigated and found to be important. The type and choice of the organic solvent(s), dispersant(s), stabilizing agent(s) used as well as the pH-value have effects on the chemical and/or physical stability of the herbicide compositions according to the present invention.

In the field of agriculture, weed control using herbicides is a key element of agronomic systems for delivering profitable crop yield. Continued investigations for (the use of) new herbicidal active ingredients (herbicides) over the years have led to the need to develop formulations (compositions) containing herbicides with different modes of action, e.g. for managing weed resistance. This invention provides for physically and chemically stable compositions containing ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (compound (A)) in the presence of the dicamba salt (compound (B)), and optionally one or more further water-soluble herbicides, such as glyphosate, at high ionic strength. The formulations according to the present invention are preferably microemulsions which may also include VaporGrip™ and/or drift retardant components for managing off-target movement of dicamba, and optionally other auxin herbicides optionally in a formulation of the present invention, making the development of said formulations more challenging. The formulations according to the present invention preferably separate the oil-soluble compound (A) from the water-soluble herbicide(s) comprising or consisting of compound (B), thereby minimizing chemical degradation of compound (A). A dispersant system comprising one or more surfactants is preferably used to stabilize the formulations of the present invention, preferably comprising or consisting of nonionic, cationic and/or anionic surfactants. Our own experiments have shown that certain phosphate ester and/or alkylpolyglucosides are particularly suitable surfactants used as dispersants in the formulations of the present invention. It was further found that through pH control, selection of an appropriate organic solvent and inclusion of a stabilizer (preferably inorganic chlorides), chemical stabilities as high as 100% for the water-soluble herbicides and up to 97% for the oil-soluble compound (A) are achievable under 54° C., 2 week accelerated aging storage conditions.

These compositions exhibited physical stability when stored at 54° C. for 2 weeks, at 40° C. for 8 weeks and at −20° C. for several weeks. Despite the chemical instability of compound (A) in solution, formulations have been developed which allow up to 100% recovery of dicamba (and glyphosate, if present) and recoveries up to 97% for compound (A) after 54° C., 2 week storage, depending on pH-value, type and amount of organic solvent, and the inclusion of stabilizers. Compositions according to the present invention tested in the green house have shown excellent weed control, and with good or improved volatility performance.

Preferably, an herbicide composition according to the present invention is a liquid herbicidal concentrate having a continuous aqueous phase and a discontinuous oil phase, the composition comprising: (a) compound (A) in said discontinuous oil phase; (b) compound (B) in said aqueous phase in the form of a microemulsion, wherein compounds (A) and (B) are present in a total concentration that is biologically effective when the composition is diluted in a suitable volume of water and applied to the foliage of a susceptible plant.

In the context of the present invention, compositions were developed in the form of physically and chemically stable microemulsions containing multiple herbicides with different modes of action (MOAs), including oil-soluble compound (A) and the water-soluble dicamba salt(s) of compound (B), both alone and in combination with glyphosate (salts). Application of such compositions can help with weed resistance management.

The herbicide compositions according to the present invention are in the form of an oil-in-water microemulsion, in particular with droplets having a certain average droplet size.

The herbicidal microemulsions preferably have an average oil droplet size smaller than 100 nm, more preferably an average oil droplet size in the range of about 1 nm to about 50 nm, in each case when measured at 25° C. and 1013 mbar. The measurements were made with a Malvern Zetasizer Nano-ZS model ZEN 3600 at 25° C. and 1013 mbar.

With this formulation type, in particular in the preferred embodiments described herein, chemical degradation of compound (A) is significantly reduced (i.e. can be largely avoided) and improved/prolonged formulation (storage) stability is achieved.

In the herbicide compositions according to the present invention the ratio by weight of the total amount of compound (A) and the total amount of compound (B) is in the range of from about 1:1 to 1:100, preferably in the range from about 1:5 to about 1:75, more preferably in the range of about 1:10 to about 1:60, and particularly preferably in the range of about 1:20 to about 1:50.

Preferably, the herbicide compositions according to the present invention comprise compound (B) in a total amount of up to about 65 wt.-%, preferably in a total amount in the range from about 10 wt.-% to about 65 wt.-%, more preferably in a total amount in the range from about 15 wt.-% to about 60 wt.-%, and particularly preferably in a total amount in the range from about 15 wt.-% to about 50 wt.-%, in each based on the total weight of the herbicide composition.

Preferably, an herbicide composition according to the present invention additionally comprises one or more further constituents selected from the group consisting of further herbicidal active compounds (i.e. herbicides different from compounds (A) and (B)), herbicide safeners, formulation auxiliaries and additives customary in crop protection.

The herbicide compositions according to the present invention may comprise one or more further herbicidal active crop protectant ingredients (in addition to compound (A) and compound (B) as defined in the context of the present invention) and/or herbicide safeners.

These, preferably water-soluble, other herbicides (herbicidal actives, herbicidal active crop protectant ingredients herbicides) and/or herbicide safeners optionally present in compositions according to the present inventions and the common names used herein are commonly known; see, for example, “The Pesticide Manual” 16th Edition, British Crop Protection Council 2012; these include the known stereoisomers (in particular racemic and enantiomeric pure isomers) and derivatives such as salts or esters, and particularly the commercially customary forms.

The herbicide compositions according to the present invention may comprise one or more further water-soluble active crop protectant ingredients in addition to compound (B) as defined in the context of the present invention.

Water-soluble further herbicides suitable for use in compositions of the invention include asulam, benazolin, bentazon, bialaphos, bromacil, bromoxynil, chloramben, clopyralid, 2,4-D, 2,4-DB, dichlorprop, difenzoquat, diquat, fenoxaprop, flamprop, fluoroglycofen, flupropanate, glufosinate, glyphosate, imazamethabenz, imazamox, imazapic, imazapyr, imazaquin, imazethapyr, ioxynil, MCPA, MCPB, mecoprop, picloram, quinclorac, sulfamic acid, 2,3,6-TBA, TCA, triclopyr and water-soluble salts thereof.

Phloem-mobile further water-soluble herbicides that are preferred for use in compositions of the invention in addition to compound (B) include but are not limited to aminotriazole, asulam, bialaphos, clopyralid, glufosinate, glyphosate, imidazolinone herbicides such as imazameth, imazamethabenz, imazamox, imazapic, imazapyr, imazaquin and imazethapyr, phenoxy herbicides such as 2,4-D, 2,4-DB, dichlorprop, MCPA, MCPB and mecoprop, picloram and triclopyr. A preferred group of further water-soluble herbicides are salts of phenoxy herbicides, imidazolinone herbicides, glufosinate and glyphosate.

If the herbicide compositions according to the present invention comprise one or more further water-soluble active crop protectant ingredients in addition to compound (B), the water-soluble active crop protectant ingredients are more preferably selected from the group consisting of glufosinate [2-amino-4-[hydroxy(methyl)phosphinoyl]butanoic acid] and salts thereof, glyphosate [N-(phosphonomethyl)glycine] and salts thereof and 2,4-D [2,4-dichlorophenoxy)acetic acid] and salts thereof, salts of glufosinate or salts of glyphosate being particularly preferred.

To allow a high concentration of one or more further water-soluble herbicidal active crop protectant ingredients in the herbicide compositions according to the present invention, the water-soluble herbicidal active crop protectant ingredients are preferably used in form of their salts since these generally speaking show higher water solubility.

The herbicide compositions according to the present invention may contain one or more further water-soluble active crop protectant ingredients selected from the group consisting of glufosinate-ammonium, glufosinate-sodium, L-glufosinate-ammonium, L-glufosinate-sodium, glyphosate-diammonium, glyphosate-dimethylammonium, glyphosate-isopropylammonium, glyphosate-monoammonium, glyphosate-potassium, glyphosate-dipotassium, glyphosate-sesquisodium (N-(phosphonomethyl)glycine sodium salt (2:3)), glyphosate-trimesium, the triethanolamine salt of glyphosate, the monoethanolamine salt of glyphosate, 2,4-D-ammonium, 2,4-D-choline, 2,4-D-BAPMA (N,N-bis-(3-aminopropyl)methylamine salt), 2,4-D-diethylammonium, 2,4-D-dimethylammonium, 2,4-D-diolamine, 2,4-D-dodecylammonium, 2,4-D-heptylammonium, 2,4-D-isopropylammonium, 2,4-D-lithium, 2,4-D-potassium, 2,4-D-sodium, 2,4-D-tetradecylammonium, 2,4-D-triethylammonium, 2,4-D-tris(2-hydroxypropyl)ammonium and 2,4-D-trolamine.

If the herbicide compositions according to the present invention comprise one or more further water-soluble active crop protectant ingredients in addition to compound (B), said further herbicidal active compound is preferably selected from the group consisting of glyphosate and salts thereof, preferably selected from the glyphosate salts mentioned hereinabove, particularly preferably the monoethanolamine salt of glyphosate.

If the herbicide compositions according to the present invention comprise one or more further water-soluble active crop protectant ingredients in addition to compound (B), said further water-soluble active crop protectant ingredients are preferably selected from group of the water-soluble active crop protectant ingredients mentioned above, preferably from the group of preferred or particularly preferably water-soluble active crop protectant ingredients mentioned above, wherein the total amounts of said water-soluble active crop protectant ingredients and of compound (B) is up to about 70 wt.-%, preferably in a in the range from about 10 wt.-% to about 65 wt.-%, more preferably in a total amount in the range from about 15 wt.-% to about 60 wt.-%, and particularly preferably in a total amount in the range from about 15 wt.-% to about 55 wt.-%, in each based on the total weight of the herbicide composition.

In some embodiments, in the herbicide compositions according to the present invention, preferably in one of the preferred, more preferred, particularly preferred embodiments or most preferred embodiments defined herein, including the embodiments defined as M1 to M288 hereinafter, the only herbicidal active ingredients in said herbicide compositions are compound (A) and compound (B).

In some embodiments, in the herbicide compositions according to the present invention, preferably in one of the preferred, more preferred, particularly preferred embodiments or most preferred embodiments defined herein, including the embodiments defined as M1 to M288 hereinafter, the only herbicidal active ingredients in said herbicide compositions are compound (A), compound (B) and a glyphosate salt, preferably the monoethanolamine salt of glyphosate.

Preferably, an herbicide composition according to the present invention comprises at least one dispersant present in a concentration sufficient to provide acceptable physical stability of the composition, in particular if the composition is in form of a microemulsion.

The herbicidal compositions of the present invention may optionally comprise one or more dispersants (anionic, cationic or zwitterionic and/or nonionic surface-active compounds (surfactants)) which are able to contribute to improved stability, in particular of compound (A), as well as further improved plant availability and/or further improved activity of the herbicidal active crop protectant ingredients present in the herbicidal compositions of the present invention.

Such dispersants may be selected, e. g. from the group of ionic polymers, like Sodium naphthalene sulphonate formaldehyde condensates or Kraft-lignosulfonate sodium salt, like Morwet D245 (Akzo Nobel) or Kraftsperse 25M (Ingevity), or from the group of non-ionic polymers, like polyethoxylated polymethacrylates, like Atlox 4913 (Croda). Such dispersants may also be selected e. g. from the group of ionic surfactants, like Dialkyl naphthalene sulfate sodium, like Oparyl MT800 (Bozetto), or non-ionic surfactants, like Tristyryl phenol alkoxylates, like Soprophor 796/P (Solvay) or block-co-polymers of ethylene/propylene oxides, like Pluronic PE 6800 (BASF). Also, C₁₂-C₁₄ fatty alcohol diethylene glycol ether sulfate sodium-, potassium-, ammonium-salts or C₁₂-C₁₄ alkyl amine ethoxylates with 4 to 8 ethylene oxide (EO) units can be used.

Preferably, an herbicide composition according to the present invention comprises at least one dispersant. In an herbicide composition according to the present invention dispersants of cationic, anionic and nonionic types may be used. However, preference is given to one or more dispersants selected from the group consisting of phosphate esters and alkylpolyglucosides (APG).

From the group of phosphate esters, preference is given to ethoxylated phosphate esters, more preferred are phosphate esters with an average of 3-5 ethylene oxide (EO) units.

In a preferred embodiment, in particular if the herbicide composition according to the present invention comprises one or more glyphosate salts, the dispersants comprise or consist of alkylpolyglucosides.

Said alkylpolyglucosides are preferably C₆-C₁₆ alkylpolyglucosides, more preferably C₈-C₁₂ alkylpolyglucosides. Preferably, said alkylpolyglucosides are C₈-C₁₂ alkylpolyglucosides with a degree of polymerization of less than 5 and in some case C₈-C₁₀ alkylpolyglucosides with a degree of polymerization of less than 2.

Such C₆-C₁₆ alkylpolyglucosides, are known in the art and commercially available, e.g. alkylpolysaccharides and mixtures thereof such as those, for example, alkylpolyglycosides in the form of the Agnique PG® grades from BASF, an example being Agnique® PG 8107 (fatty alcohol C₈-C₁₀ glucosides), Agnique® PG 9116 (fatty alcohol C₉-C₁₁ glucosides), alkylpolyglycoside/alkylpolysaccharide mixtures based on C₈-C₁₀ fatty alcohol such as Glucopon® 225 DK and Glucopon® 215 CSUP (BASF).

In a preferred embodiment, in particular if the herbicide composition according to the present invention comprises one or more glyphosate salts, the dispersants comprise or consist of alkylpolyglucosides. In an herbicidal composition according to the present invention containing a glyphosate-salt in addition to compounds (A) and (B), the ratio by weight of the total amount of glyphosate calculated as free acid (i.e. calculated as acid equivalent) to the total amount of alkylpolyglucosides is in the range of about 8:1 to 1:2, preferably in the range of about 5:1 to 1:1, more preferably in the range of about 4:1 to 3:2, in each case based on the total weight of the composition.

The herbicide compositions according to the present invention preferably comprise a substantially water-immiscible organic solvent, wherein the organic solvent is preferably selected such that compound (A) has an organic solvent/water partition coefficient, expressed as a logarithm, of about 4 or greater, preferably of about 5 or greater, more preferably of about 6 or greater, even more preferably of about 8 or greater, in each case when measured at 25° C. and 1013 mbar. A method to determine the organic solvent/water partition coefficient for compound (A) in a solvent is given in the Examples section hereinbelow.

Generally, organic solvents having a higher solubility of the oil-soluble herbicide therein are more suitable, provided the organic solvent is substantially immiscible with water.

Preferably, the herbicide compositions according to the present invention comprise one or more organic solvents, wherein (i) at least one of said organic solvents is not fully miscible with water and wherein (ii) compound (A) has a solubility of 5 wt.-% or greater, preferably of 10 wt.-% or greater, in at least one of said organic solvents, in each case when measured at 25° C. and 1013 mbar.

Full miscibility (“fully miscible”) in the context of the present invention is the property of two substances to mix in all proportions (that is, to fully dissolve in each other at any concentration or ratio), forming a homogeneous solution, in each case when measured at 25° C. and 1013 mbar.

Particularly preferably an herbicide composition according to the present invention comprises one or more organic solvents selected from the group consisting of ketones that are not fully miscible with water and aromatic hydrocarbons. Preference in turn is given to acetophenone, cyclohexanone or 4-methyl-2-pentanone and aromatic hydrocarbons C₁₀-C₁₆. Particularly preferred organic solvents are selected from the group consisting of acetophenone and mixtures of aromatic hydrocarbons C₁₀-C₁₆ (like aromatic 200 ND). Another particularly preferred organic solvent of an herbicide composition according to the present invention is benzyl acetate. The particularly preferred substantially water-immiscible organic solvents are selected from the group consisting of acetophenone, benzyl acetate and mixtures of aromatic hydrocarbons C₁₀-C₁₆, and mixtures thereof. The most preferred organic solvents in the context of the present invention are selected from the group of acetophenone and benzyl acetate.

In contrast, largely water-miscible organic solvents or fully water-miscible organic solvents, like for example acetone, acetonitrile, dioxane, ethanol and methanol, propylene glycol or propylene carbonate—although having good to excellent solvent properties for compound (A)—are not suitable as the sole or the main organic solvent in the context of the present invention.

Aromatic 200 ND is Solvent Naphtha (petroleum), Heavy Aromatic, a complex mixture of aromatic hydrocarbons, the main components thereof (typically about 50-85 wt.-%) are aromatic hydrocarbons (C₁₁-C₁₄ including 1-methylnaphthalene and 2-methylnaphthalene, as well as aromatic hydrocarbons (C₁₀), including naphthalene, and aromatic hydrocarbons (C₁₅-C₁₆), the total amount of aromatic hydrocarbons being >99 wt.-%.

Generally, the ratio by weight of the total amount of the substantially water-immiscible organic solvents, preferably selected such that compound (A) has an organic solvent/water partition coefficient, expressed as a logarithm, of about 4 or greater, preferably of about 5 or greater, more preferably of about 6 or greater, even more preferably of about 8 or greater, in each case when measured at 25° C. and 1013 mbar, to the total amount of compound (A) in an herbicide compositions according to the present invention is greater than about 1:1, preferably greater than about 2:1, more preferably greater than about 3:1.

A higher amount of organic solvent(s) generally results in a better, i.e. higher or further improved, stability of the herbicide compositions according to the present invention. Therefore, preferably, said ratio by weight of total amount of the substantially water-immiscible organic solvents to the total amount of compound (A) in an herbicide compositions according to the present invention is in the range of from about 4:1 to 40:1, more preferably in the range of from about 6:1 to 30:1, and particularly preferably in the range of from about 8:1 to 25:1.

The herbicide compositions according to the present invention preferably comprise one or more water-soluble stabilizing agents, preferably one or more water-soluble inorganic stabilizing agents, preferably selected from the group consisting of inorganic halides.

Preferred water-soluble stabilizing agents are selected from the group consisting of ammonium halides, alkali metal (preferably Na or K) halides and alkaline earth (preferably Mg or Ca) halides, more preferably selected from the group consisting of NH₄Cl (ammonium chloride), alkali metal chlorides and alkaline earth metal chlorides. Most preferred is NaCl (sodium chloride). It is also possible and sometimes more convenient to use suitable starting materials for forming said water-soluble stabilizing agent(s) in situ, e.g when using NaOH (preferably dissolved in water) and HCl (preferably in water) in the appropriate molar amounts forming NaCl and water.

The herbicide compositions according to the present invention preferably comprise one or more water-soluble stabilizing agents, wherein the stabilizing agent is present in a concentration sufficient to provide a concentration of halide ions, preferably of chloride ions, of from about 0.5% to about 2.5% by weight, based on the total weight of the composition.

The herbicide compositions according to the present invention preferably comprise one or more mono carboxylic acids and/or salts thereof, preferably one or more C₁-C₄-alkyl mono carboxylic acids and/or salts thereof, preferably the mono carboxylic acids and/or salts thereof are selected from the group consisting of formic acid, acetic acid and the salts thereof. While mono carboxylic acids and/or salts thereof may alternatively or additionally be added externally into the spray tank as off-target movement control agents, it is generally beneficial to incorporate at least a certain amount thereof into the herbicide compositions according to the present invention.

Preferably, an herbicide composition according to the present invention comprises a mono carboxylic acid at least partially neutralized with an inorganic base, preferably at least partially neutralized with an inorganic sodium base or potassium base, more preferably at least partially neutralized with sodium hydroxide or potassium hydroxide, particularly preferably at least partially neutralized with a 45% w/w potassium hydroxide solution. This general type of low volatility herbicide composition has been described in detail in U.S. Pat. No. 9,743,664.

In an herbicide composition according to the present invention the acid equivalent (a.e.) weight ratio of monocarboxylic acid, or monocarboxylate thereof, to compound (B) preferably is from about 1:10 to about 5:1.

In an herbicide composition according to the present invention the molar ratio of monocarboxylic acid, or monocarboxylate thereof, to compound (B) preferably is in the range from about 1:10 to about 10:1, preferably in the range from about 1:2 to about 6:1, more preferably in the range from about 1:1 to about 4:1.

In such an herbicide composition according to the present invention, if a neutralizing base is used to partially or fully neutralize the monocarboxylic acid(s), said neutralizing base and monocarboxylic acid preferably are combined at a molar ratio of about 1:1 (corresponding to about 100% neutralization of the monocarboxylic acid) to about 1:2 (corresponding to about 50% neutralization of the monocarboxylic acid), more preferably at a molar ratio of about 9:10 (corresponding to about 90% neutralization of the monocarboxylic acid) to about 3:5 (corresponding to about 60% neutralization of the monocarboxylic acid).

The herbicide compositions according to the present invention preferably have an acidic pH-value, i.e. a pH-value of less than 7. More specifically, the pH-value of the diluted herbicide compositions according to the present invention is in the range of about 4.5 to about 6.0, preferably in the range of about 4.8 to about 5.5, more preferably in the range of about 4.9 to about 5.3, in each case when diluted with water such that the concentration of the dicamba salt corresponds to 1.2% by weight calculated as dicamba acid (i.e. 1.2% by weight of dicamba acid equivalent) and measured at 25° C. and 1013 mbar.

The pH-value of the diluted composition obtained by dilution of an herbicide composition according to the present invention was measured using conventional pH measuring equipment, preferably by immersing the probe of a pH meter into a sample of the diluted composition. Prior to measuring pH of the diluted composition, the pH meter was calibrated in accordance with the manufacturer's recommended protocol.

The herbicide compositions according to the present invention preferably comprise a drift retardant agent (DRA), preferably one or more fatty oils, typically in a total amount in the range of about 1 wt.-% to about 10 wt.-%, preferably in the range of about 2 wt.-% to about 8 wt.-%, more preferably in the range of about 3 wt.-% to about 7 wt.-%, and particularly preferably in the range of about 4 wt.-% to about 6 wt.-%, in each case based on the total weight of the composition.

Off-site movement is a known characteristic to be managed with spray solutions containing auxin herbicides such as dicamba. To help control drift, drift retardant agents (DRAs) (also known as drift reduction agents or drift control agents) can be included in the herbicidal compositions according to the present invention. DRAs for herbicidal sprays can work by modifying the size distribution of particles formed by the nozzle, for example, by partially suppressing the formation of the smallest particles, also known as driftable fines, which settle slowest and are most prone to drift with the wind. Definitions of the size limit of “driftable fines” vary, but particles with a diameter below 150 μm are typically considered susceptible to drift.

U.S. Pat. Nos. 5,550,224, 5,874,096, 6,391,962, WO 2007/031438 and WO 2012/064370 each disclose agricultural compositions with drift control agents based on certain polymers, e.g. guar (derivatives) or certain other polymers. WO 2013/189773 relates to aqueous composition comprising dicamba and certain drift control agents. U.S. 2019/0133116A1 discloses pesticide compositions comprising an auxin herbicide and a built-in fatty acid based drift control agent.

There are typically two types of DRAs. The first type of DRA is polymers, which can increase the extensional viscosity of the spray mixture. These polymers, limited in commercial practice to polyacrylamides, polyethylene oxide, and guar gum, can shift the spray particle size distribution to larger diameters. While such polymers can be effective in reducing driftable fines for some nozzles, for example, the Turbo Teejet® Induction (TTITM) nozzle from TeeJet and the HYPRO® Ultra Lo-Drift (ULD) nozzle, they can be less preferred because they can result in significantly coarser spray, which can provide poorer coverage, compromising weed control. Furthermore, such polymers, if incorporated into an herbicidal formulation, can generally result in unacceptably high viscosity.

The second type of DRA is known as “oil-type” or “emulsion-type” DRAs. As the name suggests, an oil-type DRA, largely immiscible with water, can be included in a tank formulation as an emulsion or micro-emulsion. Drift retardants of this type are available commercially as additives to a spray tank under brand names, such as Border EG (Precision Labs) and InterLock® (Winfield). These oil-type or emulsion-type DRAs can be effective at the suppression of driftable fines, work well in a wide variety of nozzles, and can have less effect on the average particle size of the spray; thus, providing better application coverage and herbicidal efficacy.

While the use of oil-type or emulsion-type DRAs as a tank additive is common and straightforward, incorporation into an herbicidal formulation remains technically challenging, particularly for auxin herbicidal formulations with a high load of auxin herbicide, such as dicamba and 2,4-D, which are typically formulated as salts in concentrated aqueous solution.

Preferred fatty oils and (methyl) esters of fatty oils advantageously used as DRAs a part of an herbicide composition of the present invention are triglycerides of fatty acids with 12 to 24 carbon atoms or esters of fatty oils, preferably methyl esters of fatty oils, and are preferably selected from the group consisting soybean oil, an ester of soybean oil, canola oil, an ester of canola oil, palm oil, an ester of palm oil, rapeseed oil, an ester of rapeseed oil, sunflower seed oil, an ester of sunflower seed oil, corn oil, an ester of corn oil, peanut oil, an ester of peanut oil, sesame oil, an ester of sesame oil, olive oil, an ester of olive oil, castor oil and a combination thereof.

Preferred embodiment M1 of herbicide compositions according to the present invention in the form of an oil-in-water microemulsion comprises compound (A) and compound (B) as defined herein in a ratio by weight of the total amount of compound (A) and the total amount of compound (B) in the range of from about 1:1 to 1:100, a substantially water-immiscible organic solvent and one or more dispersants, wherein the pH-value of the diluted composition is less than 7.

Preferred embodiment M2 of herbicide compositions according to the present invention in the form of an oil-in-water microemulsion comprises compound (A) and compound (B) as defined herein in a ratio by weight of the total amount of compound (A) and the total amount of compound (B) in the range of from about 1:5 to 1:75, a substantially water-immiscible organic solvent such that compound (A) has an organic solvent/water partition coefficient, expressed as a logarithm, of about 4 or greater and one or more surfactants consisting of nonionic, cationic and/or anionic surfactants, wherein the pH-value of the diluted composition is in the range of about 4.5 to about 6.0 when diluted with water such that the concentration of the dicamba salt corresponds to 1.2% by weight calculated as dicamba acid and measured at 25° C. and 1013 mbar, and wherein said microemulsion comprises compound (B) in a total amount of up to about 65 wt.-%.

Preferred embodiment M3 of herbicide compositions according to the present invention in the form of an oil-in-water microemulsion comprises compound (A) and compound (B) as defined herein in a ratio by weight of the total amount of compound (A) and the total amount of compound (B) in the range of from about 1:10 to 1:60, a substantially water-immiscible organic solvent such that compound (A) has an organic solvent/water partition coefficient, expressed as a logarithm, of about 4 or greater, one or more surfactants consisting of nonionic, cationic and/or anionic surfactants, and one or more water-soluble inorganic stabilizing agents, wherein the pH-value of the diluted composition is in the range of about 4.5 to about 6.0 when diluted with water such that the concentration of the dicamba salt corresponds to 1.2% by weight calculated as dicamba acid and measured at 25° C. and 1013 mbar, and wherein said microemulsion comprises compound (B) in a total amount in the range from about 10 wt.-% to about 65 wt.-%, based on the total weight of the herbicide composition.

Preferred embodiment M4 of herbicide compositions according to the present invention in the form of an oil-in-water microemulsion comprises compound (A) and compound (B) as defined herein in a ratio by weight of the total amount of compound (A) and the total amount of compound (B) in the range of from about 1:10 to 1:60, a substantially water-immiscible organic solvent such that compound (A) has an organic solvent/water partition coefficient, expressed as a logarithm, of about 5 or greater, one or more surfactants consisting of nonionic, cationic and/or anionic surfactants, and one or more water-soluble inorganic stabilizing agents selected from the group consisting of inorganic halides, wherein the pH-value of the diluted composition is in the range of about 4.8 to about 5.5 when diluted with water such that the concentration of the dicamba salt corresponds to 1.2% by weight calculated as dicamba acid and measured at 25° C. and 1013 mbar, and wherein said microemulsion comprises compound (B) in a total amount in the range from about 15 wt.-% to about 60 wt.-%, based on the total weight of the herbicide composition.

Preferred embodiment M5 of herbicide compositions according to the present invention in the form of an oil-in-water microemulsion comprises compound (A) and compound (B) as defined herein in a ratio by weight of the total amount of compound (A) and the total amount of compound (B) in the range of from about 1:20 to 1:50, a substantially water-immiscible organic solvent such that compound (A) has an organic solvent/water partition coefficient, expressed as a logarithm, of about 6 or greater, one or more surfactants consisting of nonionic and/or anionic surfactants, and one or more water-soluble inorganic stabilizing agents selected from the group consisting of ammonium halides, alkali metal halides and alkaline earth halides, wherein the pH-value of the diluted composition is in the range of about 4.9 to about 5.3 when diluted with water such that the concentration of the dicamba salt corresponds to 1.2% by weight calculated as dicamba acid and measured at 25° C. and 1013 mbar, and wherein said microemulsion comprises compound (B) in a total amount in the range from about 15 wt.-% to about 60 wt.-%, based on the total weight of the herbicide composition.

Preferred embodiment M6 of herbicide compositions according to the present invention in the form of an oil-in-water microemulsion comprises compound (A) and compound (B) as defined herein in a ratio by weight of the total amount of compound (A) and the total amount of compound (B) in the range of from about 1:20 to 1:50, a substantially water-immiscible organic solvent such that compound (A) has an organic solvent/water partition coefficient, expressed as a logarithm, of about 6 or greater, one or more surfactants consisting of nonionic and/or anionic surfactants, and one or more water-soluble inorganic stabilizing agents selected from the group consisting of ammonium halides, alkali metal halides and alkaline earth halides, wherein the pH-value of the diluted composition is in the range of about 4.9 to about 5.3 when diluted with water such that the concentration of the dicamba salt corresponds to 1.2% by weight calculated as dicamba acid and measured at 25° C. and 1013 mbar, and wherein said microemulsion comprises compound (B) in a total amount in the range from about 15 wt.-% to about 50 wt.-%, based on the total weight of the herbicide composition.

Preferred embodiments M7 to M12 correspond to preferred embodiments M1 to M6 defined above, with the following additional feature(s):

the ratio by weight of total amount of the substantially water-immiscible organic solvents to the total amount of compound (A) in an herbicide compositions according to the present invention is in the range of from about 4:1 to 40:1, preferably in the range of from about 6:1 to 30:1, and particularly preferably in the range of from about 8:1 to 25:1, wherein the substantially water-immiscible organic solvents are preferably selected from the group consisting of acetophenone, benzyl acetate and mixtures of aromatic hydrocarbons C₁₀-C₁₆, and mixtures thereof.

Preferred embodiments M13 to M24 correspond to preferred embodiments M1 to M12 defined above, with the following additional feature(s): the one or more dispersants are selected from the group consisting of phosphate esters and/or one or more alkylpolyglucosides, and/or the stabilizing agent is present in a concentration sufficient to provide a concentration of halide ions of from about 0.5% to about 2.5% by weight, based on the total weight of the composition.

Preferred embodiments M25 to M36 correspond to preferred embodiments M1 to M12 defined above, with the following additional feature(s): the one or more dispersants are selected from the group consisting of phosphate esters with an average of 3-5 ethylene oxide (EO) units and/or one or more C₈-C₁₂ alkylpolyglucosides, and/or the stabilizing agent is present in a concentration sufficient to provide a concentration of chloride ions of from about 0.5% to about 2.5% by weight, based on the total weight of the composition.

Preferred embodiments M37 to M72 correspond to preferred embodiments M1 to M36 defined above, additionally comprising a glyphosate salt, wherein the dispersants comprise or consist of alkylpolyglucosides, wherein the ratio by weight of the total amount of glyphosate calculated as free acid (i.e. calculated as acid equivalent) to the total amount of alkylpolyglucosides is in the range of about 8:1 to 1:2, preferably in the range of about 5:1 to 1:1, more preferably in the range of about 4:1 to 3:2, in each case based on the total weight of the composition.

Preferred embodiments M73 to M144 correspond to preferred embodiments M1 to M72 defined above, additionally comprising one or more C₁-C₄-alkyl mono carboxylic acids selected from the group consisting of formic acid, acetic acid and the salts thereof, wherein the molar ratio of monocarboxylic acid, or monocarboxylate thereof, to compound (B) is in the range from about 1:10 to about 10:1, preferably in the range from about 1:2 to about 6:1, more preferably in the range from about 1:1 to about 4:1. In said preferred embodiments M73 to M144, preferably a neutralizing base and monocarboxylic acid are combined at a molar ratio of about 1:1 (corresponding to about 100% neutralization of the monocarboxylic acid) to about 1:2 (corresponding to about 50% neutralization of the monocarboxylic acid), more preferably at a molar ratio of about 9:10 (corresponding to about 90% neutralization of the monocarboxylic acid) to about 3:5 (corresponding to about 60% neutralization of the monocarboxylic acid).

Preferred embodiments M145 to M288 correspond to preferred embodiments M73 to M144 defined above, additionally comprising a drift retardant agent in a total amount in the range of about 2 wt.-% to about 8 wt.-%, more preferably in the range of about 3 wt.-% to about 7 wt.-%, and particularly preferably in the range of about 4 wt.-% to about 6 wt.-%, in each case based on the total weight of the composition.

In the above-defined embodiments M1 to M288, in a further preferred embodiment, the dicamba salt used as compound (B) comprises or consists of the diglycolamine (DGA) salt of dicamba, the N,N-bis-(3-aminopropyl)methylamine (BAPMA) salt of dicamba and/or the monoethanolamine salt of dicamba (dicamba EA).

In the above-defined embodiments M1 to M288, it is particularly preferred that compound (B) consists the diglycolamine salt of dicamba (dicamba DGA).

In the above-defined embodiments M1 to M288, it is particularly preferred that compound (B) consists of the monoethanolamine salt of dicamba (dicamba EA).

The optimum ratio ranges or amounts of the further constituents and auxiliary ingredients optionally present in a composition according to the present invention depend to some extent on the loading of the total and relative amounts of active ingredients (including compounds (A) and (B) defined in the context of the present invention).

It is also to be noted that an amount of the organic solvent(s) sufficient to provide acceptable physical stability of the composition according to the present invention (i.e. a concentration sufficient to provide acceptable physical stability) and in particular also sufficient chemical stability of compound (A), i.e. minimization of the degradation of compound (A) in the composition according to the present invention, can be readily determined by one of skill in the art by routine evaluation of a range of compositions having differing amounts of the dispersant(s). Typically, physical stability of the composition is acceptable if no significant phase separation is evident following storage for at least 7 days at any temperature in the range from about 0° C. to about 40° C.

Further, a stabilizing amount of one or more selected water-soluble halide(s) mentioned above is an amount that provides acceptable physical stability of the compositions as defined in the context of the present invention, when present along with one or more dispersant(s) in an amount insufficient on its own to provide such stability. One of skill in the art can for example readily determine such a stabilizing amount by routine evaluation of a range of compositions having differing amounts of the selected halides(s).

It is also to be noted that an amount of the dispersant(s) sufficient to provide acceptable physical stability of the composition according to the present invention (i.e. a concentration sufficient to provide acceptable physical stability) can be readily determined by one of skill in the art by routine evaluation of a range of compositions having differing amounts of the dispersant(s). Typically, physical stability of the composition is acceptable if no significant phase separation is evident following storage for at least 7 days at any temperature in the range from about 0° C. to about 40° C. Where the composition according to the present invention additionally contains one or more water-soluble halides(s) for acceptable or further improved physical stability, routine evaluation of differing amounts of the dispersant(s) is conducted in the presence of such water-soluble halides(s).

As further optional constituent or auxiliaries, the compositions of the invention can comprise customary formulation adjuvants, examples being inert materials, such as stickers, wetters, penetrants, preservatives, further inorganic salts, film forming agents, frost protectants, fillers, colorants, evaporation inhibitors and pH modifiers (buffers, acids, and bases), viscosity modifiers (e.g., thickeners) or defoamers.

Depending on the total amount of surfactants or emulsifying agents present in an herbicidal composition according to the present invention, it may be advantageous to include a defoamer as constituent of a composition of the present invention. Suitable defoamers include all customary defoamers, preferably silicone-based defoamers, such as silicone oils, for example. The silicone oils can also be used as emulsions.

Defoamers from the group of the linear polydimethylsiloxanes contain as their chemical backbone a compound of the formula HO—[Si(CH₃)₂—O—]ₙ—H, in which the end groups are modified, by etherification for example, or in general are attached to the groups —Si(CH₃)₃. Advantageous defoamers are those from the group of the linear polydimethylsiloxanes, preferably containing silica. Silica embraces forms/modifications such as polysilicic acids, meta-silicic acid, ortho-silicic acid, silica gel, silicic acid gels, kieselguhr, precipitated SiO₂, etc.

The constituents optionally used to prepare and obtain the compositions in the context of the present invention are known and many of these constituents are commercially available.

The compositions of the present invention can be prepared by conventional methods, by mixing and homogenizing the compounds (A) and (B) as well as the different constituents in solid or already dissolved form, and all other constituents, with stirring where appropriate. Depending on the formulation type and the optionally present different further constituents of the composition according to the present invention, it may be beneficial to include a milling step, e.g. using a colloid mill or stirred bead mill.

A suitable process of preparing a composition of the present invention comprises mixing the various ingredients in a suitable vessel. It is important to note that mixing is not critical to the invention and any order of addition of ingredients is suitable. However, experience to date suggests that certain orders of addition in preparing compositions of the present invention require less (reaction) time. Therefore, a presently preferred order of addition of the ingredients involves adding all required surfactants to a concentrated aqueous solution of the water-soluble herbicide along with an acid or base for pH adjustment, if desired, to form a first mixture. Compound (A) is added to the organic solvent with agitation to form a second mixture. The second mixture is then added to the first mixture with agitation to form the finished composition, i.e. a composition or formulation according to the present invention.

An alternative order of addition involves mixing a concentrated aqueous solution of compound (B) together with other, optional, water-soluble (herbicidal active) ingredients including an acid and/or base for pH adjustment, with agitation to form a first mixture. Compound (A) is then added to the organic solvent with agitation to form a second mixture. The second mixture is added to the first mixture with agitation, then the surfactants are added. Agitation is continued until a physically stable composition or formulation according to the present invention is formed.

In a further aspect, the present invention relates to a method of manufacturing the herbicide composition as defined in the context of the present invention, preferably in one of the preferred, more preferred or particularly preferred embodiments as described herein, comprising the following steps: (i) providing water and optionally one or more stabilizing agents; (ii) providing compound (B); (iii) providing compound (A) dissolved in one or more organic solvents, wherein (a) at least one of said organic solvents is not fully miscible with water and wherein (b) compound (A) has a solubility of 5 wt.-% or greater, preferably of 10 wt.-% or greater, in at least one of said organic solvents, in each case measured at 25° C. and 1013 mbar; and mixing the constituents provided in steps (i), (ii) and (iii).

The compositions of the present invention exhibit good chemical and/or physical stability, good storage properties (i.e. storage stability, including low-temperature stability) as well as allow high bioavailability, hence high activity of the crop protectant ingredients, i.e. of compounds (A) and (B).

The compositions of the present invention are especially suitable for use in crop protection for controlling unwanted plant growth both on uncultivated land and in crops tolerant to the herbicides of compounds (A) and (B) of the compositions of the present invention. Such tolerant crops can be tolerant either by nature or have been obtained by mutation/selection, or because of e.g. modifications like introduction of respective tolerance traits into transgenic plants. In this regard reference to reviews such as Plants 2019, 8, 337 or Pest Manag. Sci. 2005, 61(3), 277-85 is made.

Crops tolerant to compounds (A) and (B) can for example be cereals (e.g. barley, oat, rye, sorghum, wheat), corn (maize), cotton, oilseed rape, rice, soybean, sunflower, sugarbeet and sugarcane.

In a further aspect, the present invention relates to a method for controlling undesired plant growth which comprises applying the herbicide composition as defined in the context of the present invention, preferably in one of the preferred, more preferred or particularly preferred embodiments as described herein onto the plants, parts of plants, plant seeds or the area where the plants grow, i.e. the cultivation area.

In a preferred embodiment, the method for controlling undesired plant growth is for the selective control of harmful plants in plant crops.

In a preferred embodiment, the method for controlling undesired plant growth is for the selective control of harmful plants in plant crops of monocotyledonous plants.

In own greenhouse experiments, the herbicidal (weed control) efficacy of herbicidal compositions according to the present invention was assessed and found to be herbicidally effective against glyphosate-resistant weed species (which were in some cases also resistant to PPO (protoporphyrinogen oxidase) herbicides), such as Amaranthus palmeri (Palmer amaranth), Amaranthus tamariscinus (waterhemp) and Eleusine indica (goosegrass), see Examples section hereinbelow.

Thus, in a further aspect, the herbicidal compositions according to the present invention can be used for controlling undesired plant growth of glyphosate-resistant weed species (optionally additionally also resistant to PPO herbicides), such as glyphosate-resistant Amaranthus palmeri (Palmer amaranth), glyphosate-resistant Amaranthus tamariscinus (waterhemp) and glyphosate-resistant Eleusine indica (goosegrass).

In another embodiment, the method for controlling undesired plant growth, the plant crops are genetically modified or have been obtained by mutation/selection.

In a further aspect, the present invention relates to the use of the herbicide composition defined in the context of the present invention, preferably in one of the preferred, more preferred or particularly preferred embodiments as described herein for controlling harmful plants, i.e. for controlling unwanted plant growth.

An herbicide composition according to the present invention, in particular in one of the preferred, more preferred or particularly preferred embodiments as described herein, is typically diluted with water before application enough to be readily sprayed using standard agricultural spray equipment.

Suitable application rates for the present invention vary depending upon such factors as the concentrations of the active ingredients and the plant species involved. Useful rates for applying an aqueous composition to a field of foliage can range from about 50 liters to about 1,000 liters per hectare (1/ha), preferably about 1001/ha to about 4001/ha, by spray application.

Thus, in a further aspect the present invention relates to a tank mix composition suitable to be sprayed using standard agricultural spray equipment, wherein said tank mix composition is obtainable by mixing an herbicide composition according to the present invention with an appropriate amount of water, optionally adding one or more further ingredients selected from the group of further herbicidal active ingredients and further auxiliaries.

A weed control practitioner may choose to add one or more non-herbicidal adjuvants as tank-mix partners to the spray tank and combine such partners with an herbicide composition of the present invention. The addition of adjuvants such as crop oil concentrate (COC), methylated seed oil (MSO), certain inorganic salts or certain further surfactants to a spray tank are known to and used by the weed control practitioner in order to improve the result of herbicide application by e.g. modifying the wetting, deposition, coverage and/or penetration characteristics of the spray mixture, and of the herbicide(s) contained therein. In case of COC (adjuvants typically based on heavy petroleum oil and emulsifiers), typically about 1 vol % of COC are added to the appropriately diluted ready-to-use tank-mixture containing the herbicide composition of the present invention before application to the field.

Preferably, the total amount of water for obtaining such a tank mix composition according to the present invention is in the range of about 50 liters to about 1,000 liters, more preferably of about 100 liters to about 400 liters, per kg of herbicide composition according to the present invention.

A weed control practitioner can readily select and determine the application rates of herbicide composition according to the present invention that are herbicidally effective on particular species at particular growth stages in particular environmental conditions. Generally, preferred application rates for herbicide composition according to the present invention, in particular in one of the preferred, more preferred or particularly preferred embodiments as described herein are from about 50 to about 1500 g dicamba a. e./ha, more preferably from about 100 to about 750 g dicamba a. e./ha, even more preferably from about 150 to about 600 g dicamba a. e./ha.

Application of an herbicide composition according to the present invention, in particular in one of the preferred, more preferred or particularly preferred embodiments as described herein, to foliage of plants is preferably accomplished by spraying, using any conventional means for spraying liquids, such as spray nozzles or spinning-disk atomizers. An herbicide composition according to the present invention, in particular in one of the preferred, more preferred or particularly preferred embodiments as described herein, can be used in precision farming techniques, in which apparatus is employed to vary the amount of exogenous chemical substance applied to different parts of a field, depending on variables such as the particular plant species present, plant growth stage, soil moisture status, etc. In one embodiment of such techniques, a global positioning system operated with the spraying apparatus can be used to apply the desired amount of the composition to different parts of a field.

The herbicide compositions of the present invention can be applied to any and all plant species on which compounds (A) and/or (B) are biologically effective. Therefore, for example, the herbicide compositions of the present invention can be applied to a plant in an herbicidally effective amount, and can effectively control one or more plant species of one or more of the following genera: Abutilon, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusifze, Elymus, Equisetum, Erodium, Helianthus, Imperata, Ipomoea, Kochia, Lolium, Malva, Oryza, Ottochloa, Panicum, Paspalum, Phalaris, Phragmites, Polygonum, Portulaca, Pteridium, Pueraria, Rubus, Salsola, Setaria, Sida, Sinapis, Sorghum, Triticum, Typha, Ulex, Xanthium and Zea.

Particularly important annual broadleaf species for which the herbicide compositions of the present invention can be used are for example the following: velvetleaf (Abutilon theophrasti), pigweed (Amaranthus spp.), buttonweed (Borreria spp.), oilseed rape, canola, Indian mustard, etc. (Brassica spp.), Commelina (Commelina spp.), filaree (Erodium spp.), sunflower (Helianthus spp.), morning glory (Ipomoea spp.), kochia (Kochia scoparia), mallow (Malva spp.), wild buckwheat, smartweed, etc. (Polygonum spp.), purslane (Portulaca spp.), Russian thistle (Salsola spp.), sida (Sida spp.), wild mustard (Sinapis arvensis) and cocklebur (Xanthium spp.)

Particularly important annual narrowleaf species for which the herbicide compositions of the present invention can be used are for example the following: wild oat (Avena fatua), carpetgrass (Axonopus spp.), downy brome (Bromus tectorum), crabgrass (Digitaria spp.), barnyardgrass (Echinochloa crus-galli), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays).

Particularly important perennial broadleaf species for which the herbicide compositions of the present invention can be used are for example the following: mugwort (Artemisia spp.), milkweed (Asclepias spp.), Canada thistle (Cirsium arvense), field bindweed (Convolvulus arvensis) and kudzu (Pueraria spp.).

Particularly important perennial narrowleaf species for which for which the herbicide compositions of the present invention can be used are for example the following: brachiaria (Brachiaria spp.), bermudagrass (Cynodon dactylon), yellow nutsedge (Cyperus esculentus), purple nutsedge (Cyperus rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.).

Other particularly important perennial species for which the herbicide compositions of the present invention can be used are for example the following: horsetail (Equisetum spp.), bracken (Pteridium aquilinum), blackberry (Rubus spp.) and gorse (Ulex europaeus).

### EXAMPLES

Unless indicated otherwise, all amounts indicated in the following are in percent by weight (wt.-%).

### General Experimental Procedure to Determine the Partition Coefficient of Compound (A) in Solvents

Experimental procedure for the respective solvent: (1) A solution of 10 g of compound (A) is prepared in 90 g of the respective solvent. (2) An aliquot of 10 g of the solution obtained in step (1) is added to 90 g of water in a glass bottle, which is shaken on a mechanical shaker for 4 hours at ambient temperature (approximately 25° C.). (3) The contents of the glass bottle are permitted to phase separate for 4 days at ambient temperature (approximately 25° C.). (4) Subsamples of the resulting oil and water phases are taken and analyzed by HPLC to determine the concentrations of compound (A) in oil (Co) and water phases (Cw) respectively. The subsamples are typically centrifuged before HPLC analysis to remove traces of organic solvent from the water phase.

A Partition Coefficient, analogous to the Octanol-Water Partition Coefficient, P, is calculated as Co/Cw. The Partition Coefficient is conveniently expressed as a logarithm pKa=log Co/Cw=P.

The ratio of determined concentrations of compound (A) in the solvent phase and the water phase typically is very large. In most cases, the concentration of compound (A) in water was found to be extremely low, often below the detection limit of the HPLC method. In other cases, traces of the organic solvent are found in the water phase, even after centrifugation, so that the apparent concentration of oil-soluble herbicide observed in the water phase is misleadingly high. In own experiments for example with acetophenone or aromatic 200 ND as organic solvents, compound (A) was undetectable in the respective water phase.

### ABBREVIATIONS AND PRODUCTS USED

ae or a.e.=Acid Equivalent
ai or a.i.=(Amount of) Active Ingredient
Aromatic 200 ND=Mixture of aromatic hydrocarbons C₁₀-C₁₆
Cmp. A=ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, 98% purity
Cmp. B-1=Dicamba monoethanolamine salt, 56.2% a.e. (*)
Cmp. B-2=Dicamba monoethanolamine salt, 55.98% a.e. (*)
Cmp. B-3=Dicamba diglycolamine salt, 39.4% a.e. (**)
Cmp. B-4=Dicamba monoethanolamine salt, 56.73% a.e. (*)
Dicamba EA salt=Dicamba monoethanolamine salt
DI Water=Deionized water
DRA1=Drift Retardant, 100% soya bean oil
DRA2=Drift Retardant containing fatty acids, soya, methyl esters
Phosphate Ester=Phosphate ester with an average of 3 or 5 ethylene oxide (EO) units, phosphoric acid, may contain water
3EO PhosE=Phosphate ester with an average of 3 ethylene oxide (EO) units
5EO PhosE=Phosphate ester with an average of 5 ethylene oxide (EO) units
Polyglycoside=APG with a content of 68-72 wt.-% alkylpolyglucosides
WSH=Glyphosate monoethanolamine salt in water, 44.8% a.e.
XMAX=XtendiMax®, commercial product with Diglycolamine salt of dicamba, 42.8%
a.i.
PMAX=RoundUp PowerMAX®, commercial product with Potassium salt of Glyphosate, 48.7% a.i.
Valor® EZ=Commercial product with Flumioxazin, 41.4% a.i.
Valor® XLT=Commercial product with Flumioxazin, 30.3% a.i. and Chlorimuron ethyl, 10.3% a.i.
Fierce® MTZ=Commercial product with Flumioxazin, 5.29% a.i. and Metribuzin, 15.86% a.i. and Pyroxasulfone, 6.76% a.i.
Harness® Max=Commercial product with Acetochlor, 39.1% a.i. and Mesotrione, 3.7% a.i.
Select Max®=Commercial product with Clethodim, 12.6% a.i.
Harness® Xtra=Commercial product with Acetochlor, 46.3% a.i. and Atrazine, 18.3% a.i.
Capreno®=Commercial product with Thiencarbazone-methyl, 5.6% a.i. and Tembotrione, 28.3% a.i.
Corvus®=Commercial product with Thiencarbazone-methyl, 7.6% a.i. and Isoxaflutole, 19.0% a.i.
Warrant®=Commercial product with Acetochlor, 33.3% a.i.
Atrazine=Commercial product with Atrazine, 42.9% a.i.
MOC=Material of Construction
COC=Crop oil Concentrate
(*): Cmp. B-1 and Cmp. B-2 are two different batches of compound (B) in water produced by neutralization of dicamba (acid form) with monoethanolamine (EA)
(**): Cmp. B-3 of compound (B) in water produced by neutralization of dicamba (acid form) with diglycolamine (DGA)

The herbicidal compositions described in Tables 1 to 9 are microemulsions in accordance with the present invention with an average oil droplet size smaller than 100 nm.

### General Experimental Procedure for Producing Liquid Herbicide Concentrates in the Form of Microemulsions According to the Present Invention, in Particular Those Described in Tables 1 to 9 Hereinafter

In a vessel (formulation tank) equipped with an overhead electric stirrer (mixer motor) in step (1) DI Water is placed, followed by step (2) the addition of the water-soluble stabilizing agent(s) or suitable starting materials for forming said water-soluble stabilizing agent(s), optionally dissolved in water. During the whole experimental procedure, the content of the vessel was constantly stirred with moderate agitation. In step (3) the one or more mono carboxylic acids and/or salts thereof are added, preferably in the way that first the one or more mono carboxylic acids are added, followed by the addition of the appropriate amount of an inorganic base to at partially neutralize the one or more mono carboxylic acids previously added. Subsequently, in step (4) the dicamba salt, optionally dissolved in water, is added to the mixture, followed in step (5) by the drift retardant agent. In step (6), Cmp. A dissolved in a suitable organic solvent is added, and in last step (7) the dispersing agent(s) are added to the mixture. The whole content of the vessel was stirred for 30-45 minutes after the addition of the last ingredient, using a Caframo model 3030/AKA R20 digital or a suitable mixer at about 600 rpm, resulting in the final liquid herbicide concentrate in the form of a microemulsion.

The compositions in the following Tables 1-9C are clear microemulsion that were physically stable when stored at 54° C. for 2 weeks, at 40° C. for 8 weeks and at −20° C. for several weeks. The microemulsions exhibited good dispersion in water. The first column of each Table indicates the ingredients used to produce the respective herbicidal composition which is referenced with a Sample ID (i.e. the sample reference number) indicated in the first line of the respective column.

TABLE 1
Herbicidal Compositions with VaporGrip ™

| Ingredients | 10068464 | 10068462 | 10068466 | 10068519 | 10068547 | 10068548 |
|---|---|---|---|---|---|---|
| Cmp. B-1 | 52.77% | 55.06% | 60.30% | 41.41% | — | — |
| Cmp. B-2 | — | — | — | — | 57.30% | 51.11% |
| Cmp. A | 1.11% | 1.16% | 1.24% | 0.84% | 1.17% | 1.04% |
| Acetic Acid | 8.05% | 8.40% | 9.20% | 6.32% | 8.74% | 7.77% |
| KOH 45% in | 12.53% | 13.07% | 14.31% | 9.83% | 13.60% | 12.13% |
| water | | | | | | |
| DRA1 | — | — | — | 4.11% | — | — |
| DRA2 | 5.65% | 5.88% | — | — | — | 5.17% |
| Acetophenone | 9.99% | 4.64% | 11.11% | — | — | — |
| Aromatic 200ND | — | — | — | 7.60% | 10.51% | 9.38% |
| Phosphate Ester | 9.90% | 7.78% | 3.84% | 29.89% | 8.68% | 13.40% |
| Propylene | — | 4.01% | — | — | — | — |
| carbonate | | | | | | |
| Total: | 100.00% | 100.00% | 100.00% | 100.00% | 100.00% | 100.00% |

| Sample ID | |
|---|---|
| 10068462 | 39.49% Dicamba EA salt (30.94% ae) and 1.1% Cmp. A |
| 10068464 | 37.86% Dicamba EA salt (29.66% ae) and 1.6% Cmp. A |
| 10068466 | 43.26% Dicamba EA salt (33.89% ae) and 1.24% Cmp. A |
| 10068519 | 29.71% Dicamba EA salt (23.28% ae) and 0.84% Cmp. A |
| 10068547 | 40.96% Dicamba EA salt (32.09% ae) and 1.17% Cmp. A |
| 10068548 | 36.52% Dicamba EA salt (28.61% ae) and 1.10% Cmp. A |

TABLE 2
Herbicidal Compositions with DRA and VaporGrip ™

| Ingredients | B01 | B9 | B10 | 10069428 | B02 |
|---|---|---|---|---|---|
| Cmp. B-2 | 36.25% | 36.28 | 38.90% | 37.98% | 41.40% |
| Cmp. A | 0.75% | 0.74% | 0.79% | 0.74% | 0.84% |
| Acetic Acid | 11.02% | 11.03% | 11.82% | 11.54% | 12.58% |
| KOH 45% | 17.21% | 17.22% | 18.47% | 18.03% | 19.66% |
| in water | | | | | |
| DRA2 | 4.48% | 5.50% | 5.90% | 5.76% | 6.28% |
| Acetophenone | — | — | — | 18.20% | — |
| Aromatic | 6.79% | 17.34% | 7.14% | — | 7.61% |
| 200ND | | | | | |
| Phosphate | 8.90% | 10.67% | 9.62% | 6.47% | 9.93% |
| Ester | | | | | |
| NaCl | 0.54% | — | — | — | — |
| DI Water | 13.65% | — | 7.29% | — | — |
| NaF | 0.41% | — | 0.07% | — | — |
| Ethanolamine | — | 1.22% | — | 1.28% | — |
| HCl 50% | — | — | — | — | 0.85% |
| in water | | | | | |
| NaOH 50% | — | — | — | — | 0.85% |
| in water | | | | | |
| Total: | 100.00% | 100.00% | 100.00% | 100.00% | 100.00% |

TABLE 3
Herbicidal Compositions with DRA and VaporGrip ™

| Ingredients | A1 | A2 | 10068826 | B03 | B04 | B16 |
|---|---|---|---|---|---|---|
| Cmp. B-2 | 31.38% | 44.06% | 36.18% | 39.74% | 39.92% | 40.40% |
| Cmp. A | 0.64% | 0.90% | 0.74% | 0.81% | 0.81% | 0.82% |
| Acetic Acid | 9.54% | 6.70% | 11.00% | 12.08% | 12.13% | 12.28% |
| KOH 45% in water | 14.90% | 10.46% | 17.18% | 18.87% | 18.95% | 19.18% |
| DRA2 | 3.23% | 5.04% | 5.09% | 5.81% | 5.83% | 5.53% |
| Acetophenone | — | 8.07% | 6.63% | — | — | — |
| Aromatic 200ND | 5.75% | — | — | 7.28% | 7.33% | 7.41% |
| Phosphate Ester | 22.63% | 8.26% | 9.62% | 10.27% | 10.32% | 10.60% |
| Formic Acid | 11.93% | 16.51% | 13.56% | — | — | — |
| Ethanolamine | — | — | — | 2.98% | 2.99% | 3.78% |
| HCl 50% in water | — | — | — | 1.04% | 1.72% | — |
| NaOH 50% in | — | — | — | 1.12% | — | — |
| water | | | | | | |
| Total: | 100.00% | 100.00% | 100.00% | 100.00% | 100.00% | 100.00% |

TABLE 4
Herbicidal Compositions with DRA and VaporGrip ™

| Ingredients | B17 | B18 | B25 | B26 | B27 |
|---|---|---|---|---|---|
| Cmp. B-2 | 40.68% | 40.28% | 35.74% | 34.90% | 34.54% |
| Cmp. A | 0.83% | 0.82% | 0.73% | 0.71% | 0.70% |
| Acetic Acid | 12.36% | 12.24% | 10.86% | 10.61% | 10.50% |
| KOH 45% in | 19.31% | 19.12% | 16.97% | 16.57% | 16.40% |
| water | | | | | |
| DRA2 | 5.94% | 5.73% | 5.89% | 5.88% | 5.89% |
| Aromatic | 7.46% | 7.40% | 17.09% | 16.68% | 16.51% |
| 200ND | | | | | |
| Phosphate | 10.52% | 10.79% | 12.72% | 13.47% | 14.04% |
| Ester | | | | | |
| Ethanolamine | 2.90% | 3.62% | — | 1.18% | 1.42% |
| Total: | 100.00% | 100.00% | 100.00% | 100.00% | 100.00% |

TABLE 5
Herbicidal Compositions with DRA and VaporGrip ™

| Ingredients | B28 | B29 | B32 | B39 | B42 | B43 |
|---|---|---|---|---|---|---|
| Cmp. B-2 | 36.54% | 33.65% | 34.79% | 32.11% | 34.00% | 31.93% |
| Cmp. A | 0.75% | 0.69% | 0.71% | 0.66% | 0.87% | 0.98% |
| Acetic Acid | 11.11% | 10.23% | 10.57% | 9.76% | 10.33% | 9.70% |
| KOH 45% in | 17.35% | 15.97% | 16.51% | 15.24% | 16.14% | 15.16% |
| water | | | | | | |
| DRA2 | 6.02% | 5.86% | 5.34% | 4.33% | 5.16% | 5.44% |
| Aromatic 200ND | 11.66% | 16.08% | 16.64% | 5.90% | 20.31% | 22.91% |
| Phosphate Ester | 14.72% | 15.25% | 13.62% | 8.18% | 12.55% | 12.62% |
| NaCl | — | — | — | 3.13% | — | — |
| DI Water | — | — | — | 19.01% | — | — |
| Ethanolamine | 1.85% | 2.27% | 1.82% | 1.68% | 0.64% | 1.26% |
| Total: | 100.00% | 100.00% | 100.00% | 100.00% | 100.00% | 100.00% |

TABLE 6
Herbicidal Compositions with DRA and VaporGrip ™

| Ingredients | B53 | B54 | B56 | B58 | B59 | B134 |
|---|---|---|---|---|---|---|
| Cmp. B-2 | 30.35% | 32.06% | 33.27% | 41.48% | 28.80% | — |
| Cmp. B-3 | — | — | — | — | — | 36.09% |
| Cmp. A | 0.62% | 0.65% | 0.68% | 0.85% | 0.62% | 0.52% |
| Acetic Acid | 9.22% | 9.74% | 10.11% | 6.30% | 8.75% | 7.72% |
| KOH 45% in water | 14.41% | 15.22% | 15.80% | 9.84% | 13.67% | 11.36% |
| DRA2 | 4.55% | 4.92% | 4.99% | 4.97% | 4.48% | 5.41% |
| Acetophenone | — | 5.88% | 6.10% | 3.38% | — | — |
| Aromatic 200ND | 9.69% | — | — | — | 13.73% | 8.10% |
| Phosphate Ester | 10.92% | 9.79% | 6.92% | 11.11% | 10.47% | 10.82% |
| NaCl | 3.18% | 3.54% | 3.37% | 3.42% | 3.29% | 3.08% |
| DI Water | 17.06% | 18.20% | 18.76% | 17.25% | 16.19% | 16.90% |
| Ethanolamine | — | — | — | 1.40% | — | — |
| Total: | 100.00% | 100.00% | 100.00% | 100.00% | 100.00% | 100.00% |

TABLE 7
Herbicidal Compositions with Glyphosate with DRA and VaporGrip ™

| Ingredients | 10068721 | B51 |
|---|---|---|
| Cmp. B-2 | 16.51% | 17.03% |
| Cmp. A | 0.34% | 0.35% |
| Acetic Acid | 5.04% | 2.60% |
| KOH 45% in water | 7.84% | 4.04% |
| DRA2 | 2.47% | 2.55% |
| Aromatic 200ND | 3.02% | 5.44% |
| Phosphate Ester | 5.38% | 5.55% |
| Polyglycoside | 6.68% | 8.20% |
| WSH | 46.54% | 47.86% |
| DI Water | 6.18% | 6.38% |
| Total: | 100.00% | 100.00% |

TABLE 8
Herbicidal Compositions with Glyphosate with VaporGrip ™

| Ingredients | B5 | B13 | B24 | B50 | B52 | B61 |
|---|---|---|---|---|---|---|
| Cmp. B-2 | 16.51% | 16.74% | 15.87% | 16.41% | 15.93% | 16.68% |
| Cmp. A | 0.34% | 0.34 | 0.32% | 0.33% | 0.32% | 0.34% |
| Acetic Acid | 5.04% | 5.11% | 4.84% | 5.01% | 4.86% | 5.09% |
| KOH 45% in water | 7.84% | 7.95% | 7.54% | 7.79% | 7.5% | 7.92% |
| DRA2 | 2.47% | 2.51% | 2.38% | — | 2.39% | 2.50% |
| Acetophenone | — | — | — | — | — | 3.06% |
| Aromatic 200ND | 3.02% | 3.07% | 5.08% | 5.25% | 5.10% | — |
| Phosphate Ester | 5.38% | 4.61% | 5.71% | 5.04% | 5.40% | 3.47% |
| Polyglycoside | 6.68% | 5.11% | 7.49% | 7.78% | 7.67% | 7.62% |
| WSH | 46.54% | 47.20% | 44.76% | 46.15% | 44.80% | 47.04% |
| DI Water | 6.18% | 6.37% | 6.01% | 6.24% | 5.97% | 6.28% |
| Ethanolamine | — | 1.00% | — | — | — | — |
| Total: | 100.00% | 100.00% | 100.00% | 100.00% | 100.00% | 100.00% |

TABLE 9A
Herbicidal Compositions with Glyphosate with DRA and VaporGrip ™

| Ingredients | 10069206 |
|---|---|
| Cmp. B-2 | 15.00% |
| Cmp. A | 0.30 |
| Acetic Acid | 8.01% |
| KOH 45% in water | 12.46% |
| DRA2 | 2.45% |
| Aromatic 200ND | 2.76% |
| Phosphate Ester | 4.89% |
| Polyglycoside | 6.07% |
| WSH | 42.30% |
| DI Water | 5.76% |
| Total: | 100.00% |

TABLE 9B
Herbicidal Compositions with DRA and
VaporGrip ™ (and Glyphosate)

| Ingredients | B30 | B62 | B63 |
|---|---|---|---|
| Cmp. B-2 | 34.65% | 15.95% | 15.93% |
| Cmp. A | 0.71% | 0.33% | 0.32% |
| WSH | — | 44.99% | 44.80% |
| Acetic Acid | 10.53% | 4.87% | 4.86% |
| KOH 45% in water | 16.45% | 7.57% | 7.56% |
| DRA2 | 5.91% | 2.42% | 2.39% |
| Acetophenone | — | 2.93% | — |
| Aromatic 200ND | 16.56% | — | 5.09% |
| Phosphate Ester O3A | — | 4.99% | 5.40% |
| Phosphate Ester O5A | 13.31% | — | — |
| Agnique PG 8107 | — | 9.95% | 7.67% |
| Ethanolamine | 1.88% | — | — |
| DI Water | — | 6.00% | 5.98% |
| Total | 100.00% | 100.00% | 100.00% |

TABLE 9C
Herbicidal Compositions with VaporGrip ™ and with or without DRA

| Ingredients | B311 | B314 | B326 | B306 | B324 | B327 |
|---|---|---|---|---|---|---|
| Cmp B-4 | 52.33% | 43.56% | 45.01% | 39.11% | 48.08% | 44.85% |
| Cmp. A | 1.06% | 0.88% | 0.91% | 0.79% | 0.98% | 0.91% |
| Acetic Acid | 8.06% | 13.42% | 6.95% | 12.07% | 7.42% | 6.92% |
| KOH 45% in water | 12.42% | 20.68% | 10.68% | 18.56% | 11.41% | 10.65% |
| DRA2 | — | — | 5.60% | — | — | 5.55% |
| Acetophenone | 24.86% | 20.68% | 21.44% | — | — | — |
| Benzyl Acetate | — | — | — | 18.62% | 22.88% | 21.36% |
| Phosphate Ester | — | — | — | 9.52% | — | 9.07% |
| O3A | | | | | | |
| Phosphate Ester | 0.47% | 0.33% | 8.72% | — | 8.49% | — |
| O5A | | | | | | |
| Ethanolamine | 0.80% | 0.45% | 0.69% | 1.32% | 0.74% | 0.69% |
| Vapor | 1:1 | 2:1 | 1:1 | 2:1 | 1:1 | 1:1 |
| Grip:Dicamba | | | | | | |
| molar Ratio | | | | | | |
| Total | 100.00% | 100.00% | 100.00% | 100.00% | 100.00% | 100.00% |

Details of the respective %-recovery of compound (A), compound (B) and where applicable of Glyphosate after accelerated stability tests (54° C., 2 weeks) are shown in Tables 10 to 12.

In the Tables 11 and 12, additionally the pH-value is indicated in many cases, measured after dilution of the respective herbicidal composition with water such that the concentration of the dicamba monoethanolamine salt corresponds to 1.2% by weight calculated as dicamba acid and measured at 25° C. and 1013 mbar.

TABLE 10
Recovery of compounds (A) and (B) in %
after storage at 54° C. for 2 weeks

| | | recovery | recovery |
|---|---|---|---|
| Sample ID | Solvent | Cmp. A | Dicamba |
| 10068462 | Acetophenone | 74% | 101% |
| 10068464 | Acetophenone | 79% | 101% |
| 10068466 | Acetophenone | 69% | 101% |
| 10068519 | Aromatic | 80% | 101% |
| | 200ND | | |
| 10068547 | Aromatic | 82% | 101% |
| | 200ND | | |
| 10068548 | Aromatic | 84% | 100% |
| | 200ND | | |

The dispersant used in the compositions of Tables 1 and 10 consisted of phosphate esters with an average of 3 ethylene oxide (EO) units.

TABLE 11
Recovery of compounds (A) and (B) in %
after storage at 54° C. for 2 weeks

| | | recovery | recovery | |
|---|---|---|---|---|
| Sample ID | Dispersant | Cmp. A | Dicamba | pH-value |
| B01 | 3EO PhosE | 88% | 99% | 4.90 |
| 10068826 | 3EO PhosE | 65% | 100% | 3.45 |
| A1 | 3EO PhosE | 67% | 100% | 3.31 |
| A2 | 3EO PhosE | 56% | 100% | 3.11 |
| B61 | 5EO PhosE | 80% | 101% | 5.16 |
| B9 | 3EO PhosE | 88% | 101% | 5.26 |
| B10 | 3EO PhosE | 86% | 101% | |
| 10069428 | 5EO PhosE | 86% | 100% | |
| B02 | 3EO PhosE | 84% | 101% | |
| B16 | 3EO PhosE | 37% | 100% | 7.96 |
| B17 | 3EO PhosE | 72% | 100% | 5.84 |
| B18 | 3EO PhosE | 60% | 100% | 6.70 |
| B03 | 3EO PhosE | 60% | 100% | 6.84 |
| B04 | 3EO PhosE | 60% | 100% | |
| B25 | 5EO PhosE | 91% | 101% | 4.90 |
| B26 | 5EO PhosE | 88% | 101% | 5.18 |
| B27 | 5EO PhosE | 88% | 101% | 5.23 |
| B28 | 5EO PhosE | 83% | 101% | |
| B32 | 5EO PhosE | 88% | 100% | |
| B39 | 5EO PhosE | 89% | 99% | |
| B42 | 5EO PhosE | 96% | 98% | |
| B43 | 5EO PhosE | 97% | 98% | |
| B53 | 5EO PhosE | 97% | 102% | 5.10 |
| B54 | 5EO PhosE | 93% | 101% | 4.90 |
| B56 | 3EO PhosE | 95% | 100% | 5.05 |
| B58 | 3EO PhosE | 69% | 81% | 4.92 |
| B59 | 3EO PhosE | 97% | 100% | 4.93 |

TABLE 12
Recovery of compounds (A) and (B) and Glyphosate
in % after storage at 54° C. for 2 weeks

| | | | | recovery | |
|---|---|---|---|---|---|
| Sample | | recovery | recovery | Gly- | pH- |
| ID | Dispersant | Cmp. A | Dicamba | phosate | value |
| 10068721 | 3EO PhosE | | | | 5.10 |
| B51 | 3EO PhosE | 98% | 102% | 98% | 5.06 |
| B5 | 3EO PhosE | 92% | 105% | 99% | 5.13 |
| B13 | 3EO PhosE | 85% | 101% | 97% | 5.24 |
| B24 | 5EO PhosE | 91% | 101% | 100% | 5.13 |
| B50 | 3EO PhosE | 95% | 102% | 98% | 5.09 |
| B52 | 3EO PhosE | 97% | 102% | 98% | 5.10 |
| 10069206 | 3EO PhosE | 87% | 101% | 100% | 5.14 |
| B29 | 5EO PhosE | 97% | 102% | 100% | |
| B30 | 5EO PhosE | 93% | 100% | 98% | |

Additional chemical stability studies for compounds (A) and (B) (and optionally Glyphosate) in formulations according to the present invention.

TABLE 13
Recovery of compounds (A) and (B) (and optionally
Glyphosate) in % in the initial baseline assay

| | recovery | recovery | recovery |
|---|---|---|---|
| Sample ID | Cmp. A | Dicamba | Glyphosate |
| 10069428 | 102% | 100% | — |
| B25 | 99% | 99% | — |
| B53 | 98% | 99% | — |
| B41 | 99% | 100% | — |
| B42 | 94% | 100% | — |
| B63 | 100% | 101% | 101% |
| B62 | 104% | 101% | 103% |

TABLE 14
Recovery of compounds (A) and (B) and Glyphosate
in % after storage at room temperature after 3 months

| Sample | recovery | recovery | recovery |
|---|---|---|---|
| ID | Cmp. A | Dicamba | Glyphosate |
| 10069428 | 99% | 100% | — |
| B25 | 65% | 100% | — |
| B53 | 71% | 100% | — |
| B41 | 68% | 101% | — |
| B42 | 62% | 100% | — |
| B63 | 72% | 101% | 99% |
| B62 | 101% | 102% | 98% |

TABLE 15
Recovery of compounds (A) and (B) and Glyphosate
in % after storage at room temperature after 7 months

| | recovery | recovery | recovery |
|---|---|---|---|
| Sample ID | Cmp. A | Dicamba | Glyphosate |
| 10069428 | 96% | 102% | — |
| B25 | 67% | 102% | — |
| B53 | 70% | 101% | — |
| B62 | 98% | 104% | 98% |

### Greenhouse Trials

In greenhouse trials, the herbicidal (weed control) efficacy of some of the herbicidal compositions according to the present invention were assessed against three glyphosate-resistant weed species.

Amaranthus palmeri (AMAPA, Palmer amaranth), Amaranthus tamariscinus (AMATA, waterhemp) and Eleusine indica (ELEIN, goosegrass) plants were grown in pots in the greenhouse under standard conditions until they reached the 4 to 6 inch growth stage. Applications were made at 1401/ha with a TeeJet Turbo Induction TTI110015 nozzle.

All three weed species were resistant to glyphosate, the two Amaranthus species were additionally resistant to protoporphyrinogen oxidase (PPO) inhibitor herbicides.

Twenty-one days after application (21 DAA) the different weed species were visually rated on a percentage scale in relation to the untreated control (100%=all plants dead; 50%=green plant biomass reduced by 50%, and 0%=no discernible difference=like control plot). All trials were run with at least 24 replicates, in Table 16 the average herbicidal efficacy across all replicates is shown.

TABLE 16
Herbicidal efficacy of formulations according
to the present invention

| Sample ID | AMAPA | AMATA | ELEIN |
|---|---|---|---|
| 10068462 | 98.6% | 98.3% | 83.8% |
| 10068464 | 88.9% | 91.3% | 91.5% |
| 10068466 | 96.6% | 96.9% | 81.5% |
| 10068519 | 90.5% | 96.4% | 84.5% |
| 10068547 | 88.7% | 94.7% | 81.7% |
| 10068548 | 96.6% | 97.3% | 82.5% |
| 10069428 | 83.8% | 89.2% | 92.8% |
| 10068721 | >93% | >93% | >93% |
| B25 | 93.5% | 93.9% | 95.0% |

Tables 17 and 18 demonstrate the % control of PPO resistant weeds by Cmp. A, and Cmp. B and Cmp. A, Cmp. B and glyphosate premixes according to the present invention when compared with tank-mix sample of Cmp. A+XMAX (2-way) and Cmp. A+XMAX+PMAX (3-way). Sample 10069428 provides excellent weed control. In general, all the premix samples provided equal or better control than the respective tank-mix.

TABLE 17
Herbicidal efficacy of 2-way formulations
according to the present invention

| Treatment | AMAPA | AMATA | ELEIN |
|---|---|---|---|
| 10068464 | 92.0% | 92.1% | 93.0% |
| 10068464 + PMAX | 92.0% | 98.0% | 92.4% |
| 10069428 | 90.0% | 92.5% | 94.0% |
| 10069428 + PMAX | 94.0% | 93.0% | 94.5% |
| B25 | 94.2% | 91.0% | 93.7% |
| B25 + PMAX | 89.0% | 99.2% | 94.0% |
| B53 | 91.0% | 93.0% | 97.0% |
| B53 + PMAX | 96.0% | 93.1% | 96.2% |
| Cmp. A + | 95.1% | 92.0% | 91.0% |
| PMAX + XMAX | | | |
| Cmp. A + XMAX | 90.0% | 94.5% | 91.1% |

TABLE 18
Herbicidal efficacy of 3-way formulations
according to the present invention

| Treatment | AMAPA | AMATA | ELEIN |
|---|---|---|---|
| B52 | 89.0% | 85.0% | 90.0% |
| B62 | 86.0% | 87.0% | 95.1% |
| B63 | 87.1% | 95.2% | 90.1% |
| Cmp. A + | 90.5% | 90.1% | 89.0% |
| PMAX + XMAX | | | |

### Humidome Studies:

A humidome volatility study was performed as described in U.S. Pat. No. 9,743,664, of which its entirety is incorporated herein by reference. The average results of three replicates indicate that 10069428 has lowered volatility than XMAX. Also, tank-mixes of 10069428 and PMAX show lowered volatility than XMAX and PMAX tank-mixes.

TABLE 19
Humidome Volatility of 10069428 alone
in comparison with tank-mixes

| | Herbicide (ng/L) |
|---|---|
| | Average of 3 |
| Formulation | replicates |
| XMAX + PMAX | 0.4610 |
| XMAX | 0.0063 |
| 10069428 | 0.0046 |
| 10069428 + PMAX | 0.0927 |

### Spray Characterization Studies:

The spray particle size distribution of tank mixtures prepared from the formulations of the present invention was measured by light scattering. This technique passes a visible laser through the droplets and measures scattering, from which the distribution of droplet sizes in the spray can be determined. The measurement was performed by mounting the nozzle on a track and traversing the nozzle during the measurement so that the entire spray pattern was sampled nine times during each measurement. The spray was directed into a tray from which it was recirculated to the nozzle. No wind tunnel was used. The particle size distribution was measured with a Malvern SPRAYTEC which uses a He—Ne laser. The Malvern software integrates and weights the data to provide an overall particle size distribution for the complete spray fan and calculates the “derived parameters” which characterize the spray. The key derived parameters are the volume-weighted mean droplet diameter (Dv50) and the fraction of driftable fine particles. Several definitions of driftable fines are used. In the examples which follow, the driftable fines are quantified as the volume percent of the spray with a diameter less than 150 μm.

TABLE 20
Size and volume distribution using UR11004 Nozzle @ 50 psi

| Size | 10069428 | 10069428 + | | |
|---|---|---|---|---|
| Distribution | alone | PMAX | B62 alone | B63 alone |
| Dv10 (μm) | 341.75 ± 2.60 | 263.03 ± .79 | 231.67 ± 4.26 | 245.42 ± .90 |
| Dv50 (μm) | 665.93 ± 4.50 | 570.82 ± 1.26 | 550.85 ± 5.73 | 568.15 ± 2.43 |
| Dv90 (μm) | 1221.35 ± 9.20 | 1108.54 ± 4.79 | 1132.61 ± 14.04 | 1190.18 ± 28.95 |
| vol % < 105 μm | 0.70 ± .02 | 1.10 ± .02 | 1.86 ± .12 | 1.48 ± .03 |
| vol % < 125 μm | 1.13 ± .02 | 1.76 ± .03 | 2.83 ± .17 | 2.32 ± .05 |
| vol % < 141 μm | 1.44 ± .02 | 2.34 ± .03 | 3.67 ± .20 | 3.05 ± .06 |
| vol % < 150 μm | 1.61 ± .02 | 2.70 ± .04 | 4.17 ± .22 | 3.49 ± .06 |
| vol % < 200 μm | 2.54 ± .04 | 5.17 ± .05 | 7.41 ± .32 | 6.41 ± .07 |

TABLE 21
Size and volume distribution using UR11004 Nozzle @ 50 psi

| Size Distribution | B25 alone | B25 + PMAX | B53 alone | B53 + PMAX |
|---|---|---|---|---|
| Dv10 (μm) | no data | 272.32 ± .86 | 327.67 ± .51 | 260.17 ± .50 |
| Dv50 (μm) | no data | 593.54 ± 1.69 | 652.84 ± 2.03 | 576.89 ± 2.24 |
| Dv90 (μm) | no data | 1196.74 ± 6.02 | 1212.69 ± 10.5 | 1123.43 ± 7.43 |
| vol % < 105 μm | no data | 0.99 ± .01 | 0.75 ± .01 | 1.24 ± .01 |
| vol % < 125 μm | no data | 1.61 ± .01 | 1.21 ± .01 | 1.96 ± .02 |
| vol % < 141 μm | no data | 2.15 ± .02 | 1.56 ± .01 | 2.59 ± .02 |
| vol % < 150 μm | no data | 2.48 ± .02 | 1.75 ± .01 | 2.97 ± .02 |
| vol % < 200 μm | no data | 4.74 ± .04 | 2.90 ± .01 | 5.51 ± .02 |

TABLE 22
Size and volume distribution using AI 8005 Nozzle @ 40 psi;
Note: XMAX alone 3.0% < 150 μm on this nozzle

| Size | 10069428 | 10069428 + | | |
|---|---|---|---|---|
| Distribution | alone | PMAX | B62 alone | B63 alone |
| Dv10 (μm) | 352.39 ± .45 | 284.42 ± .85 | 266.14 ± 2.73 | 277.72 ± 2.03 |
| Dv50 (μm) | 699.30 ± 1.96 | 631.11 ± 1.30 | 670.05 ± 4.71 | 666.64 ± 1.28 |
| Dv90 (μm) | 1351.84 ± 8.45 | 1368.13 ± 7.45 | 1556.44 ± 4.67 | 1505.08 ± 4.09 |
| vol % < 105 μm | 0.91 ± .01 | 1.27 ± .02 | 1.90 ± .05 | 1.56 ± .06 |
| vol % < 125 μm | 1.32 ± .01 | 1.82 ± .03 | 2.57 ± .06 | 2.15 ± .08 |
| vol % < 141 μm | 1.60 ± .01 | 2.28 ± .03 | 3.12 ± .07 | 2.64 ± .09 |
| vol % < 150 μm | 1.74 ± .01 | 2.55 ± .03 | 3.45 ± .07 | 2.93 ± .10 |
| vol % < 200 μm | 2.49 ± .01 | 4.40 ± .04 | 5.66 ± .12 | 4.94 ± .13 |

TABLE 23
Size and volume distribution using AI 8005 Nozzle @ 40 psi;
Note: XMAX alone 3.0% < 150 μm on this nozzle

| Size Distribution | B25 alone | B25 + PMAX | B53 alone | B53 + PMAX |
|---|---|---|---|---|
| Dv10 (μm) | 372.74 ± 1.13 | 303.65 ± 11.77 | 372.19 ± 1.17 | 301.80 ± 6.42 |
| Dv50 (μm) | 716.41 ± 6.19 | 660.25 ± 14.95 | 727.78 ± 1.55 | 662.18 ± 4.12 |
| Dv90 (μm) | 1363.48 ± 17.67 | 1407.19 ± 12.36 | 1407.67 ± 5.88 | 1447.33 ± 33.55 |
| vol % < 105 μm | 0.74 ± .02 | 1.03 ± .15 | 0.66 ± .01 | 1.10 ± .10 |
| vol % < 125 μm | 1.12 ± .02 | 1.50 ± .20 | 1.00 ± .02 | 1.56 ± .13 |
| vol % < 141 μm | 1.36 ± .02 | 1.87 ± .25 | 1.22 ± .02 | 1.92 ± .15 |
| vol % < 150 μm | 1.48 ± .01 | 2.09 ± .28 | 1.33 ± .02 | 2.14 ± .16 |
| vol % < 200 μm | 1.97 ± .01 | 3.59 ± .48 | 1.88 ± .03 | 3.65 ± .26 |

### Mixing Properties Experiment

Mixing properties of selected premix samples according to the present invention including formulations 10069428 and B25 were conducted with and without 1% by volume Crop Oil Concentrate (COC) to investigate any issues when products are diluted in hard water to prepare spray solution. Nessler tubes were filled with required amount of water, followed by the required amount COC and then the required amount of herbicide sample. The results indicated that each of the herbicides provide excellent mixing with observable bloom, no initial mixing issues and no separation when left for 24 hours.

### Co-Herbicide Compatibility Experiment

Compatibility studies were conducted to investigate tank-mixing properties of formulations 10069428, B25 (2-way) and B62 (3-way) with selected tank-mix partners (PMAX, Atrazine, Valor® EZ, Valor® XLT, Fierce® MTZ, Harness® Max, Select Max®, Harness® Xtra, Capreno®, Corvus® and Warrant®). Nessler tubes were filled with required amount of water, followed by the required amount COC and then the required amount of herbicide sample and tank-mix partner. The results indicated that each of the samples had excellent co-herbicide tank-mix compatibility with observable bloom, no initial mixing issues and no separation when left for 24 hours.

### Material of Construction (MOC) Studies

Formulations 10069428 and B25 were evaluated for impact on MOCs such as stainless steels 304 L, 316 L and 2205 (stainless and elastomers, typical material of construction) at 23° C. and 49° C. temperatures for 28 days. In addition, Electrochemistry (CPP) Functional Assay for Stainless Steel Compatibility Test were also conducted to check the propensity of localized corrosion attack. The results indicated that formulations 10069428 and B25 have no adverse effect on MOC.

What is claimed is:

1. A herbicide composition in the form of an oil-in-water microemulsion comprising compounds (A) and (B), wherein:
(A) denotes ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate; and
(B) denotes one or more dicamba salts.

2. The herbicide composition as claimed in claim 1, wherein compound (B) is selected from the group consisting of the tetrabutylamine salt of dicamba, the dimethylamine salt of dicamba, the isopropylamine salt of dicamba, the diglycolamine salt of dicamba, the N,N-bis-(3-aminopropyl)methylamine salt of dicamba, the choline salt of dicamba, the monoethanolamine salt of dicamba, the diethanolamine salt of dicamba, the triethanolamine salt of dicamba, the potassium salt of dicamba, and the sodium salt of dicamba.

3. The herbicide composition as claimed in claim 1, wherein the ratio by weight of the total amount of compound (A) and the total amount of compound (B) is in the range of from about 1:1 to 1:100.

4. The herbicide composition as claimed in claim 1, comprising compound (B) in a total amount of up to about 65 wt.-%, based on the total weight of the herbicide composition.

5. The herbicide composition as claimed in claim 1, further comprising one or more further constituents selected from the group consisting of other herbicidal active compounds, herbicide safeners, formulation auxiliaries and additives customary in crop protection.

6. The herbicide composition as claimed in claim 5, wherein the additionally present herbicidal active compound is selected from the group consisting of glyphosate and salts thereof.

7. The herbicide composition as claimed in claim 1, further comprising at least one dispersant, preferably one or more dispersants selected from the group consisting of phosphate esters and/or one or more alkylpolyglucosides.

8. The herbicide composition as claimed in claim 1, further comprising a substantially water-immiscible organic solvent, wherein the organic solvent is preferably selected such that compound (A) has an organic solvent/water partition coefficient, expressed as a logarithm, of about 4 or greater.

9. The herbicide composition as claimed in claim 1, further comprising one or more water-soluble stabilizing agents.

10. The herbicide composition as claimed in claim 1, further comprising one or more water-soluble stabilizing agents selected from the group consisting of inorganic halides, wherein the stabilizing agent is present in a concentration sufficient to provide a concentration of halide ions of from about 0.5% to about 2.5% by weight, based on the total weight of the composition.

11. The herbicide composition as claimed in claim 1, further comprising one or more mono carboxylic acids and/or salts thereof.

12. The herbicide composition as claimed in claim 1, wherein the pH-value of a diluted composition is less than 7, when diluted with water such that the concentration of the dicamba salt corresponds to 1.2% by weight calculated as dicamba acid and measured at 25° C. and 1013 mbar.

13. The herbicide composition as claimed in claim 1, further comprising a drift retardant agent.

14. The herbicide composition as claimed in claim 1, wherein compound (B) is selected from the group consisting of the diglycolamine salt of dicamba, the N,N-bis-(3-aminopropyl)methylamine salt of dicamba, the monoethanolamine salt of dicamba, the diethanolamine salt of dicamba and the triethanolamine salt of dicamba.

15. A method for controlling undesired plant growth, comprising applying the herbicide composition as defined in claim 1 onto the plants, parts of plants, plant seeds or the area where the plants grow.

16. The use of the herbicide composition defined in claim 1 for controlling harmful plants.

17. A method of manufacturing the herbicide composition defined in claim 1, comprising the following steps:
(i) providing water and optionally one or more stabilizing agents;
(ii) providing compound (B);
(iii). providing compound (A) dissolved in one or more organic solvents, wherein (a) at least one of said organic solvents is not fully miscible with water and wherein (b) compound (A) has a solubility of 5 wt.-% or greater, in at least one of said organic solvents, measured at 25° C. and 1013 mbar;
mixing the constituents provided in steps (i), (ii) and (iii).

18. The herbicide composition as claimed in claim 1, comprising compound (B) in a total amount in the range from about 10 wt.-% to about 65 wt.-%, based on the total weight of the herbicide composition.

19. The herbicide composition as claimed in claim 18, further comprising one or more further constituents selected from the group consisting of other herbicidal active compounds, herbicide safeners, formulation auxiliaries and additives customary in crop protection.

20. The herbicide composition as claimed in claim 19, wherein the additionally present herbicidal active compound is selected from the group consisting of glyphosate and salts thereof.

21. The herbicide composition as claimed in claim 1, further comprising at least one dispersant selected from the group consisting of phosphate esters and/or one or more alkylpolyglucosides.

22. The herbicide composition as claimed in claim 18, further comprising a substantially water-immiscible organic solvent, wherein the organic solvent is preferably selected such that compound (A) has an organic solvent/water partition coefficient, expressed as a logarithm, of about 4 or greater.

23. The herbicide composition as claimed in claim 18, further comprising one or more water-soluble stabilizing agents.

24. The herbicide composition as claimed in claim 1, further comprising one or more water-soluble stabilizing agents selected from the group consisting of inorganic halides, wherein the stabilizing agent is present in a concentration sufficient to provide a concentration of halide ions of from about 0.5% to about 2.5% by weight, based on the total weight of the composition.

25. The herbicide composition as claimed in claim 1, further comprising one or more C₁-C₄-alkyl mono carboxylic acids and/or salts thereof.

26. The herbicide composition as claimed in claim 1, wherein the pH-value of a diluted composition is in the range of about 4.5 to about 6.0 when the composition is diluted with water such that the concentration of the dicamba salt corresponds to 1.2% by weight calculated as dicamba acid and measured at 25° C. and 1013 mbar.

27. The herbicide composition as claimed in claim 1, further comprising a drift retardant agent selected from one or more fatty oils in a total amount in the range of about 1 wt.-% to about 10 wt. % based on the total weight of the composition.

28. The herbicide composition as claimed in claim 18, wherein compound (B) is selected from the group consisting of the diglycolamine salt of dicamba, the N,N-bis-(3-aminopropyl)methylamine salt of dicamba, the monoethanolamine salt of dicamba, the diethanolamine salt of dicamba and the triethanolamine salt of dicamba.

29. A method for controlling undesired plant growth, comprising applying the herbicide composition as defined in claim 18 onto the plants, parts of plants, plant seeds or the area where the plants grow.

30. The use of the herbicide composition defined in claim 18 for controlling harmful plants.

31. A method of manufacturing the herbicide composition defined in claim 1, comprising the following steps:
(i) providing water and optionally one or more stabilizing agents;
(ii) providing compound (B);
(iii). providing compound (A) dissolved in one or more organic solvents, wherein (a) at least one of said organic solvents is not fully miscible with water and wherein (b) compound (A) has a solubility of 5 wt.-% or greater, in at least one of said organic solvents, measured at 25° C. and 1013 mbar;
mixing the constituents provided in steps (i), (ii) and (iii).
